(19) United States
(12) Patent Application Publication
(10) Pub. No.: US 2024/0279096 A1
(43) Pub. Date: Aug. 22, 2024

(54) PASSIVE AEROBIC TREATMENT UNIT AND METHOD OF USE

(71) Applicant: WAIHOME LLC, Haleiwa, HI (US)

(72) Inventor: James Roberts, Haleiwa, HI (US)

(21) Appl. No.: 18/442,273

(22) Filed: Feb. 15, 2024

Related U.S. Application Data
(63) Continuation-in-part of application No. PCT/US2022/075637, filed on Aug. 30, 2022.
(60) Provisional application No. 63/240,211, filed on Sep. 2, 2021.

(51) Int. Cl. C02F 3/06; C02F 1/02; C02F 1/30; C02F 3/34; C02F 103/00; F24S 50/80

(52) U.S. Cl. CPC C02F 3/06; C02F 1/02; C02F 1/30; C02F 3/34; F24S 50/80; C02F 2103/005; C02F 2201/009; C02F 2203/006

(57) ABSTRACT

The present invention recognizes that there exists a long felt and unfulfilled need for a photobioreactor for treatment of wastewater (Passive Aerobic Treatment Unit (PATU). As a non-limiting introduction to the breadth of the present invention, the present invention includes several general and useful aspects, including but not limited to: a) a device or system for the passive treatment of a preferably liquid wastewater stream using autotrophic, phototrophic, and heterotrophic microorganisms growing in a photobioreactor; and b) a method of treating wastewater using the devices of the present invention.

### PRIORITY

The present application is:
a Continuation in Part of PCT Application PCT/US2022/075637, filed Aug. 30, 2022, currently pending, which
claims benefit of priority to U.S. Provisional application Ser. No. 63/240,200, filed Sep. 2, 2021, now expired;
each of which is incorporated by reference in their entirety herein.

### TECHNICAL FIELD

The present invention generally relates to devices for the treatment of water, waste, and wastewater, such as but not limited to sewage, industrial wastewater, agricultural wastewater, grey water, and household wastewater, by way of a biofilm that can be optionally photosynthetically active and to methods of using such devices of the present invention. In particular, the present invention pertains to a method and a device, which permits passive wastewater and sewage treatment with extensive organic and nutrient removal, as well as chemical removal, through the nitrification and denitrification cycle, biomass production, or a combination thereof, or through bioremediation of unwanted chemical pollutants or components. The methods can be but not limited to aerobic, anaerobic, photosynthetic, or a combination thereof.

### BACKGROUND OF THE INVENTION

Biofilm photobioreactors (PBRs) are an emerging biological treatment technology for decentralized wastewater treatment. Biofilm PBRs rely on the action of algae and bacteria, within a biofilm (which can be a monolayer or of multiple layers, such as but not limited to colonization of a surface by microbes), to remove organics, nutrients, and contaminants of concern from water that is recirculated across it. Algae growth produces oxygen under illuminated conditions, which can subsequently be utilized by aerobic or facultative bacteria to degrade organic matter and produce carbon dioxide. The carbon dioxide can then be utilized as a carbon source by algae (Boelee et al., 2014). Nutrient removal is achieved through assimilation into algal and bacterial biomass but can also be supplemented by nitrification and denitrification under the appropriate redox conditions.

Biofilm systems are known to be inherently robust and relatively insensitive to fluctuations in influent concentrations and loading rate (Westerling, 2014). Due to their relatively low maintenance and energy inputs, biofilm PBRs can be amenable for decentralized wastewater treatment (Zamalloa et al., 2013). Assuming a natural light source, the only energy input for existing biofilm PBRs is for pumped recirculation, cycling water across the illuminated surface on which the biofilm grows. Study of PBR systems in the lab has increased, as made evident by the following reports:

Zamalloa et al., (2013) generally report that an open (for example, unsealed) rooftop biofilm PBR using municipal wastewater and exposed to sunlight on a 16 hour to 8 hour diel cycle was an effective means of small-scale tertiary treatment to reach reuse-quality effluent.

Posadas et al., (2013) generally report the possibility of achieving both secondary and tertiary treatment within an open PBR. In this case, the comparative effectiveness of a 16 hour to 8 hour light-dark cycled PBR and an unlit PBR was tested under varying hydraulic retention times and recycle rates.

Boelee et al., (2014) generally report the behavior of a closed (for example, sealed) biofilm PBR operated with continuous lighting and synthetic wastewater. It was reported that the PBR required alkalinity addition to build a symbiotic algal-bacterial biofilm but not to maintain it. However, the photoactive irradiance was only sufficient to support heterotrophic oxidation, inhibiting nitrification and its associated alkalinity demand.

Roberts et al., (2019) generally report the comparative efficiency of parallel closed and open biofilm PBR's operated under 16 hour to 8 hour light dark cycles.

Tuantet et al., (2019) generally report the nutrient removal capacity of Chlorella Sorokiniana algae from lightly diluted urine at high temperatures in a pumped flat panel photobioreactor.

U.S. Pat. No. 8,198,076, Photobioreactor and Uses Therefor, generally reports a PBR configuration that pumps wastewater through a flat-panel suspended culture photobioreactor featuring a gas diffuser for mixing.

U.S. Pat. No. 8,895,279, Applications of the Rotating Photobioreactor, generally reports a PBR configuration that is a variation of a typical rotating biofilter.

U.S. Pat. No. 9,487,748 B2, Dual-Compartment Bioreactor For Use in Wastewater Treatment and Algal Production, generally reports a PBR configuration that treats wastewater in adjacent autotrophic (lit) and heterotrophic (unlit) zones. A membrane between the two zones facilitates the diffusion of carbon dioxide, oxygen, and nutrients between zones while keeping the suspended biological communities separate.

U.S. Pat. No. 9,896,652 B2, Photobioreactor, System and Method of Use, generally reports a PBR configuration that pumps wastewater through a flexible film photobioreactor enclosure outfitted with a gas diffuser to support a suspended algal culture.

U.S. Pat. No. 10,927,334, Photobioreactor Systems and Methods, generally reports a PBR configuration that features a rotating flexible biofilm cultivation surface that facilitates algae growth and harvesting.

US 2011/0151507 A1, Solar Biofactory Photobioreactors, Passive Thermal Regulation Systems and Methods for Producing Products, generally reports methods of regulating temperatures inside flat-panel photobioreactors.

Thermosyphoning is a technique based on natural convection and commonly employed in solar hot water heaters that allows for the recirculation of a fluid without the necessity of a mechanical pump.

WO 2001067008A1, Solar Water Heater, generally reports a solar hot water heater configuration that employs a plastic solar collector panel coupled at the high end to a hot water storage tank and cool water is returned to the base of the collector via a single pipe.

U.S. Pat. No. 7,398,779 B2, Thermosiphoning System With Side Mounted Storage Tanks, generally reports a solar hot water heater configuration whereby the hot water storage tank is situated adjacent to the solar collector panel and cool water is returned to the base of the collector via a single pipe.

U.S. Pat. No. 6,014,968, A Tubular Heating-Pipe Solar Water-Heating-System with Integral Tank, generally reports a solar hot water heater configuration whereby the hot water tank is coupled to the high end of a solar collector panel comprised of a plurality of heat-absorbing pipes and cool water returns to the base of the solar collector panel via return pipes located within the heat-absorbing pipes.

US 20080000435 A1, Solar Thermal Tube Plate Heat Exchanger, generally reports a solar hot water heater and radiator for absorbing heat from the sun during the day and dissipating it back to the atmosphere at night.

U.S. Pat. No. 6,119,682, A Water Heater and Storage Tank, generally reports a solar hot water heater configuration whereby a low-profile hot water tank is integrated into the solar collector panel and heat transfer fluid is used in lieu of water within the panel.

U.S. Pat. No. 9,746,205 B2, Double Layer Solar Heating-and-Cooling Thermosyphon System, generally reports a solar hot water configuration that employs both layered heating and cooling tubes to improve thermosyphonic flow between hot and cold water storage tanks during marginal solar conditions.

Thermosyphoning may be used in photobioreactors to achieve passive recirculation to compliment its existing passive aeration process.

PCT/US22/75637, Passive Wastewater Treatment Unit and Method of Use, generally reports an algae photobioreactor with parallel illuminated and shaded conduits separated by a divider plate to induce thermosiphon-based recirculation.

BA Cho et al., (2018) generally report a Thermosiphon Photobioreactor (TPBR) geometry made of five main sections (i) adiabatic vertical cylindrical storage tank, (ii) truncated cone-shaped cooling section, and (iii) adiabatic downcomer, (iv) heating section (collector/absorber) and (v) adiabatic upriser. Cooling was accomplished at the cooling section using a cooling jacket. The study tested the TPBR's ability to recirculate water and transport a suspended monoculture of Rhodopseudomonas Palustris. Biofilm formation was inhibited through the use of smooth surfaces. The system was designed to produce hydrogen via biofermentation.

Bosman et al., (2022) generally reports testing the hydrogen production potential of the TPBR described by BA Cho et al., (2018).

### BRIEF SUMMARY OF THE INVENTION

The present invention recognizes that there exists a long felt and unfulfilled need for a passive photobioreactor for treatment of wastewater (Passive Aerobic Treatment Unit (PATU)).

As a non-limiting introduction to the breadth of the present invention, the present invention includes several general and useful aspects, including but not limited to:
1. a device or system for the passive treatment of a preferably liquid wastewater stream using autotrophic, phototrophic, and heterotrophic microorganisms in a photobioreactor;
2. a device or system to create a convective recirculation cycle in a device preferably installed in-line with the influent and effluent pipes;
3. a device or system to create convective recirculation cycle between a device and a settling chamber;
4. a method of treating wastewater using the methods of the devices of the present invention. The methods can be aerobic, anaerobic, or a combination thereof. The methods can be autotrophic, heterotrophic, mixotrophic, or a combination thereof.

These aspects of the present invention, as well as others described herein, can be achieved by using the methods, articles of manufacture and compositions of matter described herein. To gain a full appreciation of the scope of the present invention, it can be further recognized that various aspects of the present invention can be combined to make desirable embodiments of the invention.

### BRIEF DESCRIPTION OF THE DRAWINGS

Figure Elements (In General)
(1) Influent Line
(2) Effluent Line
(3) Transparent Top Face
(4) Illuminated Conduit
(5) Divider Plate (can be Insulative)
(6) Shaded Conduit
(7) Opaque Back Face
(8) Settling Chamber
(9) Gas Relief Valve
(10) Lower End Wall
(11) Shaded series of conduits
(12) Heat Exchange Pipe Material
(13) Illuminated series of conduits
(14) Transparent Pipe Material
(15) Incident Radiation
(16) Heat Exchange with Outside Environment
(17) Upper End Wall
(18) Baffles
(19) Upper Manifold
(20) Lower Manifold
(21) Biofilm
(22) Siphon Break
(23) Hydraulic Grade Line
(24) Inlet Valve
(25) Outlet Valve

FIG. 1A generally depicts a general view of a PATU installed in conjunction with a septic tank or settling chamber. Element 1 generally refers to an influent line carrying preferably pretreated liquid wastewater into the PATU. Element 24 generally refers to the inlet valve on the influent line. Element 2 generally refers to an effluent line carrying treated wastewater from the PATU. Element 25 generally refers to the outlet valve on the effluent line. Element 3 generally refers to a transparent top face that admits incident radiation into an illuminated conduit that is at least intermittently illuminated by said incident radiation. Element 4 generally refers to an at least intermittently illuminated conduit in which a preferably photosynthesizing biofilm can grow. Element 5 generally refers to a divider plate that thermally separates the shaded and at least intermittently illuminated conduits and shades the shaded conduit from incident radiation. Element 6 generally refers to a shaded conduit between the divider plate and opaque back face which are sufficiently opaque to reduce incident radiation into the conduit such that a preferably non-photosynthesizing biofilm can grow. Element 7 generally refers to an opaque back face through which the shaded conduit exchanges heat with the ambient environment. Element 8 generally refers to a settling chamber or septic tank from which a PATU recirculates water. Element 9 generally refers to a gas relief valve from which gases can be removed from the PATU. Element 10 generally refers to the lower end wall where the influent line and effluent line connect to the shaded and at least intermittently illuminated conduits, respectively. Element 17 generally refers to the upper end wall of the PATU where the shaded and at least intermittently illuminated conduits join. Element 15 generally refers to the incident radiation that at least intermittently falls upon the at least intermittently illuminated conduit. Element 16 generally refers to the heat that is exchanged between the shaded conduit and the ambient environment. Element 23 generally refers to the hydraulic grade line of the system.

FIG. 1B generally depicts an elevation view of FIG. 1A. Element 21 generally refers to the biofilm that coats the interior of the PATU.

FIG. 2A generally depicts a general view of a PATU with rectangular shaded and at least intermittently illuminated conduits installed in-line with an influent and effluent pipe. Element 1 generally refers to an influent line carrying preferably pretreated liquid wastewater into the PATU. Element 24 generally refers to the inlet valve on the influent line. Element 2 generally refers to an effluent line carrying treated wastewater from the PATU. Element 25 generally refers to the outlet valve on the effluent line. Element 3 generally refers to a transparent top face that admits incident radiation into an illuminated conduit that is at least intermittently illuminated by said incident radiation. Element 4 generally refers to an at least intermittently illuminated conduit in which a preferably photosynthesizing biofilm can grow. Element 5 generally refers to a divider plate that thermally separates the shaded and at least intermittently illuminated conduits and shades the shaded conduit from incident radiation. Element 6 generally refers to a shaded conduit between the divider plate and opaque back face which are sufficiently opaque to reduce incident radiation into the conduit such that a preferably non-photosynthesizing biofilm can grow. Element 7 generally refers to an opaque back face through which the shaded conduit exchanges heat with the ambient environment. Element 9 generally refers to a gas relief valve from which gases can be removed from the PATU. Element 10 generally refers to the lower end wall where the shaded and at least intermittently illuminated conduits join. Element 17 generally refers to the upper end wall of the PATU where the shaded and at least intermittently illuminated conduits join. Element 15 generally refers to the incident radiation that at least intermittently falls upon the at least intermittently illuminated conduit. Element 16 generally refers to the heat that is exchanged between the shaded conduit and the ambient environment. Element 22 generally refers to the siphon break following the PATU. Element 23 generally refers to the hydraulic grade line of the system.

FIG. 2B generally depicts an elevation view of FIG. 2A. Element 21 generally refers to the biofilm that coats at least a portion of the interior of the PATU.

FIG. 3A generally depicts a general view of a PATU installed in-line with an influent and effluent pipe, and replacing the rectangular conduits with a series of tubular conduits to enhance convective recirculation. Element 1 generally refers to an influent line carrying preferably pretreated liquid wastewater into the PATU. Element 24 generally refers to the inlet valve on the influent line. Element 2 generally refers to an effluent line carrying treated wastewater from the PATU. Element 25 generally refers to the outlet valve on the effluent line. Element 14 generally refers to the transparent pipe material that admits incident radiation into an illuminated series of conduits that are at least intermittently illuminated by said incident radiation. Element 13 generally refers to an illuminated series of conduits that are at least intermittently illuminated in which a preferably photosynthesizing biofilm can grow. Element 5 generally refers to a divider plate that thermally separates the shaded and at least intermittently illuminated conduits and shades the shaded conduits from incident radiation. Element 11 generally refers to a shaded series of conduits in which a preferably non-photosynthesizing biofilm can grow. Element 12 generally refers to the heat exchange pipe material through which the shaded conduits exchange heat with the ambient environment. Element 19 generally refers to the manifold that connects the at least intermittently illuminated conduits to the shaded conduits at the top of the panel. Element 20 generally refers to the manifold that connects the at least intermittently illuminated conduits to the shaded conduits at the bottom of the panel. Element 9 generally refers to a gas relief valve from which gasses can be removed from the PATU. Element 15 generally refers to the incident radiation that at least intermittently falls upon the at least intermittently illuminated conduits. Element 16 generally refers to the heat that is exchanged between the shaded conduits and the ambient environment. Element 22 generally refers to the siphon break following the PATU. Element 23 generally refers to the hydraulic grade line of the system.

FIG. 3B generally depicts an elevation view of FIG. 3A. Element 21 generally refers to the biofilm that coats at least a portion of the interior of the PATU.

FIG. 4A generally depicts a general view of a PATU installed in-line with an influent and effluent pipe, and replacing rectangular conduits with a series of tubular conduits that are baffled to prevent hydraulic short circuiting. Element 1 generally refers to an influent line carrying preferably pretreated liquid wastewater into the PATU. Element 24 generally refers to the inlet valve on the influent line. Element 2 generally refers to an effluent line carrying treated wastewater from the PATU. Element 25 generally refers to the outlet valve on the effluent line. Element 14 generally refers to the transparent pipe material that admits incident radiation into a illuminated series of conduits that are at least intermittently illuminated by said incident radiation. Element 13 generally refers to an illuminated series of conduits that are at least intermittently illuminated in which a preferably photosynthesizing biofilm can grow. Element 5 generally refers to a divider plate that thermally separates the shaded and at least intermittently illuminated conduits and shades the shaded conduits from incident radiation. Element 11 generally refers to a shaded series of conduits in which a preferably non-photosynthesizing biofilm can grow. Element 12 generally refers to the heat exchange pipe material through which the shaded conduits exchange heat with the ambient environment. Element 19 generally refers to the manifold that connects the at least intermittently illuminated conduits to the shaded conduits at the top of the panel. Element 20 generally refers to the manifold that connects the at least intermittently illuminated conduits to the shaded conduits at the bottom of the panel. Element 9 generally refers to a gas relief valve from which gasses can be removed from the PATU. Element 15 generally refers to the incident radiation that at least intermittently falls upon the at least intermittently illuminated conduits. Element 16 generally refers to the heat that is exchanged between the shaded conduits and the ambient environment. Element 18 generally refers to the baffles that inhibit hydraulic short circuiting through the PATU. Element 22 generally refers to the siphon break following the PATU. Element 23 generally refers to the hydraulic grade line of the system.

FIG. 4B generally depicts an elevation view of FIG. 4A. Element 21 generally refers to the biofilm that coats at least a portion of the interior of the PATU.

FIG. 5A generally depicts a general view of a PATU installed in-line with an influent and effluent pipe with tubular conduits and no divider plate to enhance convective cooling. Element 1 generally refers to an influent line carrying preferably pretreated liquid wastewater into the PATU. Element 2 generally refers to an effluent line carrying treated wastewater and/or process gases from the PATU. Element 14 generally refers to the transparent pipe material that admits incident radiation into a illuminated series of conduits that are at least intermittently illuminated by said incident radiation. Element 13 generally refers to a illuminated series of conduits that are at least intermittently illuminated in which a preferably photosynthesizing biofilm can grow. Element 11 generally refers to a shaded series of conduits that are shaded from incident radiation by the illuminated series of conduits and an enclosing heat exchange pipe material that is sufficiently opaque that a preferably non-photosynthesizing biofilm can grow. Element 12 generally refers to the heat exchange pipe material through which the shaded conduits exchange heat with the ambient environment. Element 19 generally refers to the manifold that connects the at least intermittently illuminated conduits to the shaded conduits at the top of the panel. Element 20 generally refers to the manifold that connects the at least intermittently illuminated conduits to the shaded conduits at the bottom of the panel. Element 9 generally refers to a gas relief valve from which gasses can be removed from the PATU. Element 15 generally refers to the incident radiation that at least intermittently falls upon the at least intermittently illuminated conduits. Element 16 generally refers to the heat that is exchanged between the conduits and the ambient environment.

FIG. 5B generally depicts an elevation view of FIG. 5A. Element 21 generally refers to the biofilm that coats at least a portion of the interior of the PATU.

FIG. 6A generally depicts a general view of a tubular PATU installed in-line with an influent and effluent pipe with the shaded conduits situated between the at least intermittently illuminated conduits and the source of radiation in order to shield the at least intermittently illuminated conduits from excess incident radiation. Element 1 generally refers to an influent line carrying preferably pretreated liquid wastewater into the PATU. Element 2 generally refers to an effluent line carrying treated wastewater and/or process gases from the PATU. Element 14 generally refers to the transparent pipe material that at admits incident radiation into a illuminated series of conduits that are at least intermittently illuminated by said incident radiation. Element 13 generally refers to an illuminated series of conduits that are at least intermittently illuminated in which a preferably photosynthesizing biofilm can grow. Element 11 generally refers to a shaded series of conduits that are shaded from incident radiation by the enclosing heat exchange pipe material such that a preferably non-photosynthesizing can biofilm grow. Element 12 generally refers to the heat exchange pipe material through which the shaded conduits exchange heat with the ambient environment. Element 19 generally refers to the manifold that connects the at least intermittently illuminated conduits to the shaded conduits at the top of the panel. Element 20 generally refers to the manifold that connects the at least intermittently illuminated conduits to the shaded conduits at the bottom of the panel. Element 15 generally refers to the incident radiation that at least intermittently falls upon the at least intermittently illuminated conduits. Element 16 generally refers to the heat that is exchanged between the conduits and the ambient environment.

FIG. 6B generally depicts an elevation view of FIG. 6A. Element 21 generally refers to the biofilm that coats at least a portion of the interior of the PATU.

FIG. 7A generally depicts a general view of a tubular PATU installed in-line with an influent and effluent pipe and an illuminated series of conduits that are at least intermittently illuminated and a shaded series of conduits that are at least intermittently shaded oriented preferably with the two faces pointing in the general East-West direction. Element 1 generally refers to an influent line carrying preferably pretreated liquid wastewater into the PATU. Element 2 generally refers to an effluent line carrying treated wastewater and/or process gases from the PATU. Element 14 generally refers to the transparent pipe material that admits incident radiation into an illuminated series of conduits and shaded series of conduits in sequence. Element 13 generally refers to an illuminated series of conduits that are at least intermittently illuminated in which a preferably photosynthesizing biofilm can grow. Element 11 generally refers to a shaded series of conduits that are at least intermittently shaded from incident radiation by the illuminated series of conduits and in which a preferably photosynthesizing biofilm can grow. Element 19 generally refers to the manifold that connects the at least intermittently illuminated conduits and the at least intermittently shaded conduits at the top of the panel. Element 20 generally refers to the manifold that connects the at least intermittently illuminated conduits and the at least intermittently shaded conduits at the bottom of the panel. Element 15 generally refers to a moving source of incident radiation that at least intermittently falls upon the at least intermittently illuminated conduits while they shade the at least intermittently shaded conduits and at least intermittently falls upon the at least intermittently shaded conduits while they shade the at least intermittently illuminated conduits. Element 16 generally refers to the heat that is exchanged between the conduits and the ambient environment.

FIG. 7B generally depicts an elevation view of FIG. 7A. Element 21 generally refers to the biofilm that coats at least a portion of the interior of the PATU.

FIG. 8A generally depicts a general view of a tubular PATU installed in-line with an influent and effluent pipe and an illuminated series of conduits that are at least intermittently illuminated and a shaded series of conduits that are at least intermittently shaded oriented preferably with the two faces pointing in the general East-West direction and separated by a divider plate. Element 1 generally refers to an influent line carrying preferably pretreated liquid wastewater into the PATU. Element 2 generally refers to an effluent line carrying treated wastewater and/or process gases from the PATU. Element 14 generally refers to the transparent pipe material that admits incident radiation into the at least intermittently illuminated conduits and at least intermittently shaded conduits in sequence. Element 13 generally refers to an illuminated series of conduits that are at least intermittently illuminated in which a preferably photosynthesizing biofilm can grow. Element 11 generally refers to a shaded series of conduits in which a preferably photosynthesizing biofilm can grow that are at least intermittently shaded from incident radiation by the divider plate. Element 19 generally refers to the manifold that connects the at least intermittently illuminated conduits and the at least intermittently shaded conduits at the top of the panel. Element 20 generally refers to the manifold that connects the at least intermittently illuminated conduits and the at least intermittently shaded conduits at the bottom of the panel. Element 15 generally refers to a moving source of incident radiation that at least intermittently falls upon the at least intermittently illuminated conduits and at least intermittently falls upon the at least intermittently shaded conduits. Element 5 generally refers to a divider plate located between the at least intermittently illuminated and at least intermittently shaded conduits that ensures only the at least intermittently illuminated conduits or the at least intermittently shaded conduits are exposed to incident radiation at a time. Element 16 generally refers to the heat that is exchanged between the conduits and the ambient environment.

FIG. 8B generally depicts an elevation view of FIG. 8A. Element 21 generally refers to the biofilm that coats at least a portion of the interior of the PATU.

### DETAILED DESCRIPTION OF THE INVENTION

### Definitions

Unless defined otherwise, all technical and scientific terms used herein have the same meaning as commonly understood by one of ordinary skill in the art to which this invention belongs. Generally, the nomenclature used herein and the laboratory procedures in microbiology and environmental engineering described below are well known and commonly employed in the art. Conventional methods are used for these procedures, such as those provided in the art and various general references such as Metcalf & Eddy Inc., Tchobanoglous, G., Burton, F. L., Tsuchihashi, R., & Stensel, H. D. (2013). Wastewater engineering: Treatment and resource recovery (5th ed.). McGraw-Hill Professional. Where a term is provided in the singular, the inventors also contemplate the plural of that term. The nomenclature used herein, and the laboratory procedures described below, are those well-known and commonly employed in the art. As employed throughout the disclosure, the following terms, unless otherwise indicated, shall be understood to have the following meanings:

“Nitrification” is the oxidation of ammonium to nitrate under oxic conditions.

“Denitrification” is the reduction of nitrate to nitrogen gas under anoxic conditions.

Other technical terms used herein have their ordinary meaning in the art that they are used, as exemplified by a variety of technical dictionaries.

### INTRODUCTION

A Passive Aerobic Treatment Unit (PATU) of the present invention was developed as a device and associated method to provide the passive benefit of photosynthetic aeration while also eliminating or reducing the requirement for pumped recirculation or mixing.

The device, called a Passive Aerobic Treatment Unit (PATU), in one general embodiment, generally includes at least or in part:
(a) at least one at least intermittently illuminated conduit or series of conduits oriented on an angle from the horizontal and adapted for holding fluid, comparable in dimensions to a solar panel that:
   (i) are made at least in part from a transparent material that admits incident radiation and facilitates its absorption in the fluid contained within;
   (ii) are made at least in part from a possibly thermally insulative material that may conduct some heat between the treatment unit and the ambient environment;
   (iii) contains at least in part sufficiently textured inside surfaces to facilitate the development of a robust biofilm;
   (iv) hydraulically connects the top of the at least intermittently shaded conduit to the bottom of the at least intermittently shaded conduit thus creating a circuit;
(b) optionally, at least one opaque and/or insulative divider plate that:
   (i) thermally separates the at least intermittently illuminated conduit(s) from the at least intermittently shaded conduit(s) except where the conduits join at the top and bottom of the panel;
   (ii) can be varied in color to absorb or reflect incident radiation as needed to optimize the temperature and incident radiation exposure of the conduit(s);
   (iii) functions to at least intermittently shade the shaded conduit(s) and optionally the at least intermittently illuminated conduit(s) from incident radiation exposure;
(c) at least one at least intermittently shaded conduit or series of conduits that:
   (i) are optionally made from opaque, translucent or transparent material
   (ii) can have a sufficiently textured surface to support biofilm development
   (iii) optionally exists in the shadow of the divider plate;
   (iv) hydraulically connect the top of the at least intermittently illuminated conduit to the bottom of the at least intermittently illuminated conduit thus creating a circuit;
   (v) facilitate the dissipation of heat to or from the treatment unit and thereby facilitate convective recirculation as thermal energy enters the at least intermittently illuminated conduit and leaves the at least intermittently shaded conduit or vice versa;
   (vi) facilitate the transfer of heat to and from the treatment unit and thereby facilitate convective recirculation as a result of imbalanced heating of the at least intermittently illuminated conduit and the at least intermittently shaded conduit;
(d) at least one circuit between the at least intermittently illuminated and at least intermittently shaded conduits that can exist above or below the hydraulic grade line of the influent without draining because any part of the circuit above the hydraulic grade line is sealed and thereby acts as an unbroken siphon;
(e) at least one inlet port and one outlet port that allow water to passively flow into and out of the treatment unit as the addition of wastewater causes the hydraulic head at the inlet to increase relative to the hydraulic head at the outlet;
(f) at least one inlet and outlet port configuration, with or without baffles, that prevents hydraulic short-circuiting through the PATU; and
(g) optionally, at least one geometry at the base of the at least intermittently illuminated and at least intermittently shaded conduits to facilitate the conveyance of sloughed biofilm to the outlet port.
(h) Optionally, at least one geometry at the top of the at least intermittently illuminated and at least intermittently shaded conduits to facilitate the conveyance of sloughed biofilm and gas to the outlet port.

In a first preferred embodiment of the present invention, the PATU can be installed above a septic tank or settling chamber. This configuration includes at least or in part:
(a) optionally, at least one settling chamber with an untreated wastewater inlet pipe on one end and disposal pipe at the other;
(b) at least one influent line that rises from under the water surface in the settling chamber to the base of the at least one at least intermittently illuminated conduit(s) above;
(c) at least one effluent line that descends from the base of the at least one at least intermittently shaded conduit(s) to under the water surface of the settling chamber;
(d) at least one baffle that separates the PATU at least one influent and at least one effluent ports in the settling chamber;
(e) at least one unbroken hydraulic circuit that follows the influent line up from the settling chamber into the illuminated conduit(s), connects to the shaded conduit(s) at the top of the PATU, and descends from the base of the shaded conduit(s) back to the settling chamber; and
(f) at least one biofilm separation by settling in the settling chamber.

In a second preferred embodiment of the present invention, the PATU with at least one intermittently illuminated conduit(s) and at least one shaded conduit(s) can be installed in-line with a filled wastewater line. This configuration includes at least or in part:
(a) optionally, at least one solids removal process before the PATU;
(b) optionally, at least one solids removal process after the PATU;
(c) at least one at least intermittently illuminated conduit(s) and an at least one shaded conduit(s) connected at both ends of the PATU to form a hydraulic circuit;
(d) at least one inlet port and at least one outlet port positioned so as to minimize hydraulic short circuiting; and
(e) at least one siphon break following the PATU so as to prevent total drainage of the system.

In a third preferred embodiment of the present invention, the PATU with at least one intermittently illuminated conduit(s) and at least one intermittently shaded conduit(s) that are both intermittently irradiated in turn can be installed in-line with at least one filled wastewater line. This configuration includes at least or in part:
(a) optionally, at least one solids removal process before the PATU;
(b) optionally, at least one solids removal process after the PATU;
(c) at least one at least intermittently illuminated conduit(s) and an at least one at least intermittently shaded conduit(s) connected at either end of the PATU to form a hydraulic circuit;
(d) at least one at least intermittently illuminated conduit(s) made at least in part from a transparent material that admits radiation and facilitates radiation's absorption in the fluid contained within;
(e) at least one at least intermittently shaded conduit(s) made at least in part from a transparent material that admits radiation and facilitates radiation's absorption in the fluid contained within;
(f) at least one vertical panel orientation preferably facing the general east-west direction such that in the morning the at least one at least intermittently illuminated conduit(s) is illuminated and the at least one at least intermittently shaded conduit is shaded by the shadow of the at least intermittently illuminated conduit and in the afternoon the at least one at least intermittently shaded conduit(s) is illuminated and the at least one at least intermittently illuminated conduit(s) is shaded by the shadow of the at least one at least intermittently shaded conduit;
(g) optionally, at least one divider plate separating the at least one at least intermittently illuminated conduit(s) and the at least one at least intermittently shaded conduit(s) to assist in providing thermal separation and shading between the at least one at least intermittently illuminated conduit(s) and the at least one at least intermittently shaded conduit(s);
(h) at least one inlet port and at least one outlet port positioned so as to minimize hydraulic short circuiting; and
(i) optionally, at least one siphon break following the PATU so as to prevent total drainage of the system.

### I. Device for the Treatment of Wastewater

A first aspect of the present invention includes a photobioreactor (Passive Aerobic Treatment Unit (PATU)) for treating wastewater from a preferably liquid influent stream using at least one biofilm, including: a) at least one at least intermittently illuminated conduit(s) oriented on an angle from the horizontal with a transparent face to admit incident radiation and pass heat to or from the outside environment; b) at least one at least intermittently shaded conduit(s) that runs preferably underneath, above, or parallel to the at least one at least intermittently illuminated conduit(s) and passes heat to or from the outside environment, and can also be intermittently irradiated; c) at least one connection between the at least one at least intermittently illuminated conduit(s) and the at least one at least intermittently shaded conduit(s) at high and low points such that the wastewater recirculates by convection as a result of imbalanced heating or cooling of the at least one at least intermittently illuminated conduit(s) and the at least one at least intermittently shaded conduit(s); d) at least one biofilm provided on at least a portion of at least one internal surface of the device; e) illumination means for applying incident radiation to the at least one at least intermittently illuminated conduit(s) and the microorganisms therein and optionally the at least intermittently shaded conduit(s) and the microorganisms therein; f) optionally, an at least one insulative divider plate situated between the at least one at least intermittently shaded conduit(s) and the at least one at least intermittently illuminated conduit(s) that supports the thermal separation of the at least intermittently shaded conduit(s) and the at least one at least intermittently illuminated conduit(s); g) at least one inlet port and at least one outlet port; and h) optionally, an at least one gas relief valve.

### Illuminated Conduit

An aspect of the present invention includes wherein the at least one at least intermittently illuminated conduit(s) includes at least one flat panel conduit that includes at least in part at least one transparent top face to admit incident radiation.

The at least one at least intermittently illuminated conduit(s) can have textured internal surfaces to encourage biofilm attachment. The transparent top face can be made from any appropriate transparent or translucent material. Depending on the environment in which the present invention is installed, the thermal conductivity, transmissivity, and thickness of the transparent top face can be selected to optimize internal temperatures, convective recirculation, and photoactive radiation levels for algal and bacterial growth and activity. Preferably, the material can be one of acrylic, polyethylene, polycarbonate, clear PVC, GFRP, glass, or a combination thereof.

Another aspect of the present invention includes whereby the at least one at least intermittently illuminated conduit(s) includes a series of parallel transparent conduits that admit incident radiation.

The at least one series of parallel transparent conduits can have textured internal surfaces to encourage biofilm attachment. The at least one parallel transparent conduits can be made from any appropriate transparent or translucent material. Depending on the environment in which the present invention is installed, the thermal conductivity, transmissivity, and thickness of the parallel transparent conduits can be selected to optimize internal temperatures, convective recirculation, and photoactive radiation levels for algal and bacterial growth and activity. Preferably, the material can be one of acrylic, polyethylene, polycarbonate, clear PVC, GFRP, glass, or a combination thereof.

### Shaded Conduit

A further aspect of the present invention includes wherein the at least one at least intermittently shaded conduit(s) includes a heat exchange element.

The at least one at least intermittently shaded conduit(s) can have textured internal surfaces to encourage biofilm attachment.

The at least intermittently shaded conduit(s) can include at least one flat panel conduit that is preferably situated underneath or beside the at least one at least intermittently illuminated conduit(s) and has at least one opaque back face that selects for a preferably non-photosynthesizing biofilm.

The at least one opaque back face can be made from any appropriate thermally conductive material. Preferably, the material can be one of black steel, stainless steel, polycarbonate, copper, aluminum, fiberglass, PVC, ABS, CPVC, polyethylene, acrylic, or a combination thereof.

An additional aspect of the present invention includes wherein the at least one at least intermittently shaded conduit(s) includes a series of thermally conductive parallel heat exchange conduits that are preferably situated underneath, beside, or above the at least one at least intermittently illuminated conduit(s) and increase the area available for heat exchange.

An aspect of the present invention includes whereby the parallel heat exchange conduits can be made from any appropriate opaque and thermally conductive material to select for a preferably non-photosynthesizing biofilm. Preferably, the material can be one of black steel, stainless steel, polycarbonate, copper, aluminum, fiberglass, PVC, ABS, CPVC, polyethylene, acrylic, or a combination thereof.

Another aspect of the present invention includes whereby the PATU is installed generally vertically with the two faces oriented preferably in the East-West direction such that the at least intermittently illuminated conduit(s) is irradiated in the morning and the at least intermittently shaded conduit(s) is irradiated in the evening.

The at least intermittently shaded conduit(s) can include at least one flat panel conduit that is preferably situated beside at least one at least intermittently illuminated conduit(s) and has at least one transparent face.

The at least one transparent face can be made from any appropriate transparent or translucent material. Depending on the environment in which the present invention is installed, the thermal conductivity, transmissivity, and thickness of the transparent top face can be selected to optimize internal temperatures, convective recirculation, and photoactive radiation levels for algal and bacterial growth and activity. Preferably, the material can be one of acrylic, polyethylene, polycarbonate, clear PVC, GFRP, glass, or a combination thereof.

The transparent at least intermittently shaded conduit(s) can alternatively include a series of parallel conduits that optimize heat dissipation from the PATU. The parallel conduits can be made from any appropriately transparent or translucent material. Depending on the environment in which the present invention is installed, the thermal conductivity, transmissivity, and thickness of the parallel transparent conduits can be selected to optimize internal temperatures, convective recirculation, and photoactive radiation levels for algal and bacterial growth and activity. Preferably, the material can be one of acrylic, polyethylene, polycarbonate, clear PVC, GFRP, glass, or a combination thereof.

### Connection of Conduits

Another aspect of the present invention includes wherein the at least one at least intermittently illuminated conduit(s) and the at least one at least intermittently shaded conduit(s) connect: a) at the upper end of the device; b) at the lower end of the device; c) by way of at least one settling chamber from which the at least one influent pipe ascends to the at least one at least intermittently illuminated conduit(s), and to which the at least one effluent pipe descends from the at least one at least intermittently shaded conduit(s).

Untreated water can be introduced to the settling chamber and treated water can withdrawn from the settling chamber. The at least one settling chamber can be used for primary clarification and secondary clarification before and after the treatment using the present invention, respectively. Baffling may be used to prevent hydraulic short-circuiting within the settling chamber.

A further aspect of the present invention includes wherein the at least one at least intermittently illuminated conduit(s) and the at least one at least intermittently shaded conduit(s) connect at the upper end of the device and again at the lower end of the device and the at least one influent pipe and the at least one effluent pipe connect to the upper end and lower end of the device or vice versa.

In the case where the at least one at least intermittently illuminated conduit(s) and at least one at least intermittently shaded conduit(s) include a series of conduits, manifold connections can be used to connect the at least one at least intermittently shaded conduit(s) to the at least one at least intermittently illuminated conduit(s) at the upper and lower ends of the device. The manifold can be made from any appropriate material that is stable in water. Preferably, the material can be one of aluminum, PVC, ABS, polyethylene, brass, black steel, stainless steel, nylon, copper, chrome, PLA, PET, polypropylene, acrylic, polycarbonate, or a combination thereof. Manifolds may be connected to the at least intermittently illuminated conduit(s) and at least intermittently shaded conduit(s) and each other using any appropriate bonding agent, cement, adhesive, epoxy, sealant, gasket, o-ring, or a combination thereof, designed for use with the materials to be adjoined.

### Biofilm

An additional aspect of the present invention includes wherein the biofilm comprises autotrophic, phototropic, mixotrophic, chemotrophic, heterotrophic microorganisms, or a combination thereof.

The biofilm can be any appropriate pure or mixed culture, or a combination thereof. Preferably, the biofilm can include heterotrophic, mixotrophic, and autotrophic microorganisms, or a combination thereof. Preferably, autotrophic microorganisms can include nitrifying or phototrophic microorganisms, or a combination thereof. Preferably heterotrophic microorganisms can include denitrifying or facultative microorganisms, or a combination thereof.

Preferably, nitrifying microorganisms can include one or more of the genera Nitrobacter, Nitrococcus, Nitrosococcus, Nitrosomonas, Nitrosovibrio, Nitrospina, Nitrospira, and SM1A02, or a combination thereof. Preferably, nitrifying microorganisms can include one or more of the species Nitrobacter alkalicus, Nitrobacter hamburgensis, Nitrobacter vulgaris, Nitrobacter winogradskyi, Nitrococcus mobilis, Nitrosococcus nitrosus, Nitrosomonas aestuarii, Nitrosomonas cryotolerans, Nitrosomonas communis, Nitrosomonas europaea, Nitrosomonas eutropha, Nitrosomonas halophila, Nitrosomonas marina, Nitrosomonas mobilis, Nitrosomonas nitrosa, Nitrosomonas oligotropha, Nitrosomonas stercoris, Nitrosomonas ureae, and Nitrospira inopinata, or a combination thereof. Preferably, denitrifying microorganisms can include one or more of the genera Achromobacter, Aeromonas, Alcaligenes, Bacillus, Dechloromonas, Flavobacterium, Haliangium, Micrococcus, Oligotropha, Paracoccus, Pseudomonas, Rhodoferax, Serratia, Sulfurtalea, Thaucra, Thermomonas, Thiobacillus, and Zoogloca. Preferably, denitrifying microorganisms can include one or more of the species Micrococcus denitrificans, Pseudomonas Aeruginosa, Thauera terpenica, Thiobacillus denitrificans, and Zoofloca ramigera, or a combination thereof.

Other heterotrophic and autotrophic genera of microorganisms can include one or more of the genera Acinetobacter, Alcaligenes, Alicycliphilus, Alsobacter, Akkermansia, Bauldia, Blastocatella, Brevibacterium, Brevifollis, Brevundimonas, Bryobacter, Caldininea, Calothrix, Candidatus Accumulibacter, Arenimonas, Caulobacter, Chryscobacterium, Cloacibacterium, Clostridium, Comomonas, Cytophage, Defluviimonas, Dinhuibacter, Dokdonella, Duganella, Ferruginibacter, Fimbriiglobus, Flavihumibacter, Flavobacterium, Haliangium, Hirschia, Holophaga, Hyphomicrobium, Janthinobacterium, Kaistia, Lactobacillus, Lactococcus, Leptospira, Luteibacter, Mesorhizobium, Methylorosula, Microbacterium, Mycobacterium, Niabella, Novosphingobium, Paracaedibacter, Paucibacter, Pedobacter, Polaromonas, Propionivibrio, Pseudomonas, Pseudolabrys, Ralstonia, Reyranella, Rhodanobacter, Rhizobacter, Rudaca, Simplicipira, Sphaerotilus, Sphingopyxis, Tabrizicola, Turneriella, Undibacterium, Woodsholea, and Yersinia, or a combination thereof.

Preferably, photosynthesizing microorganisms can include one or more of the genera Anabaena, Bacillariophyta, Botryococcus, Characium, Chlamydomonas, Chlorella, Desmodesmus, Dunaliella, Euglena, Haematococcus, Monoraphidium, Navicula, Nitzschia, Oocystis, Oscillatoria, Pichochlorum, Phormidium, Pseudocharaciopsis, Scenedesmus, Stigeoclonium, Synechocystis, Trichormus, and Tychonema. Preferably, photosynthesizing microorganisms can include one or more of the species Anabaena augstmalis, Botryococcus braunii, Chlorella minutissima, Chlorella sorokiniana, Chlorella vulgaris, Phormidium autumnale, Scenedesmus acutus, Scenedesmus quadricauda, Scenedesmus obliquus, Synechocystis aquatilis, and Trichormus variabilis, or a combination thereof.

An aspect of the present invention includes wherein the biofilm is provided on the at least one at least intermittently illuminated conduit(s), the at least one at least intermittently shaded conduit(s), or a combination thereof.

### Illumination Means

Another aspect of the present invention includes wherein the illumination means includes: a) direct sunlight; b) sunlight passed through a window or light filter; c) sunlight redirected using a solar tube, fiberoptics, or reflector; d) artificial full spectrum lighting; e) artificial lighting optimized for photosynthetic active radiation; f) bioluminescence; g) nuclear radiation; or h) a combination thereof.

Illumination can provide a means of photosynthesis and a driver for convective recirculation, or a combination thereof, to support the growth of microorganisms. Illumination can be optimized for the growth of the microorganisms.

### Insulative Divider Plate

An optional further aspect of the present invention includes wherein the at least one insulative divider plate shades the at least intermittently shaded conduit(s), reflects or absorbs incident radiation as needed to optimize the temperature, convective recirculation, and incident radiation exposure of the at least intermittently illuminated conduit(s) for the growth of microorganisms inside the device, and thermally separates the shaded and at least intermittently illuminated conduit(s) except where they meet at the upper and lower ends of the device.

An optional further aspect of the present invention includes wherein an at least one insulative divider plate shades one of the at least intermittently shaded and at least intermittently illuminated conduit(s) at a time to induce convective recirculation and reflects or absorbs incident radiation as needed to optimize the temperature, convective recirculation, and incident radiation exposure for the growth of microorganisms inside the device, and thermally separates the at least intermittently illuminated and at least intermittently shaded conduit(s) except where they meet at the upper and lower ends of the device.

The insulative divider plate can preferably be made from any appropriately insulative, opaque, and lightweight material. Preferably, the material can be one of foam insulation, structural foam, twin-wall polycarbonate, glass, fiberglass, polystyrene, PET, polypropylene, PVC, polycarbonate, acrylic, wood, tile, aluminum vacuum chamber, composite, MDF, or a combination thereof.

### Inlet Port and Outlet Port

An additional aspect of the present invention includes wherein the at least one inlet port transports influent into the device.

An aspect of the present invention includes wherein the at least one outlet port transports effluent out of the device.

The at least one outlet port can be positioned at the base of the device to facilitate transport of settled biofilms out with the effluent. The at least one outlet port can be positioned at the top of the device to minimize suspended solids leaving the device and evacuate process gases. The at least one outlet port should be positioned so as to minimize hydraulic short circuiting from the at least one inlet port. The at least one outlet port should be sufficiently sized to pass any biofilms suspended in the effluent.

### Gas Relief Valve

An optional aspect of the present invention includes wherein an at least one gas relief valve is provided at the top of the device for removing gas build-up.

The at least one gas relief valve can preferably be any manual or active gas-tight valve that allows gas to leave but not enter the device. The at least one gas relief valve can be triggered to release gas by any level sensing device located at the top of the device.

A further aspect of the present invention includes wherein the at least one gas relief valve is connected to a pump to facilitate removing gas build-up as the at least one gas relief valve is above the hydraulic grade line.

An additional aspect of the present invention includes wherein the at least one gas relief valve can passively release gas by gravity as the at least one gas relief valve is below the hydraulic grade line.

### Additional Configurations

An aspect of the present invention further includes baffles within the device that are used to prevent hydraulic short-circuiting.

The baffles can be located within the upper and lower manifolds to force water to snake its way through the device. Small gas holes can be made in the baffles in the upper manifold to allow gas to traverse the upper manifold to the gas relief valve. Small solids holes can be made in the baffles in the lower manifold to allow settled solids to traverse the lower manifold to the effluent port. The baffles can be made of any appropriate material that is stable in water. Preferably, the material can be one of PVC, aluminum ABS, polyethylene, brass, black steel, nylon, copper, chrome, glass, PLA, PET, polypropylene, acrylic, polycarbonate, or a combination thereof.

Another aspect of the present invention includes wherein the device is mounted as a skylight or window between two environments and the temperature difference between the two environments is used to drive the convective recirculation of the device.

In this configuration, the at least intermittently illuminated conduit(s) can be made from any transparent or translucent material with high thermal conductivity.

A further aspect of the present invention includes wherein the device includes at least one tank to store untreated wastewater, partially treated wastewater, treated wastewater, or a combination thereof.

The at least one tank can precede, follow, or be integrated into the convective loop in order to increase the hydraulic retention time of the device.

An additional aspect of the present invention includes wherein multiple devices are connected in parallel.

An aspect of the present invention includes wherein multiple devices are connected in series.

Another aspect of the present invention includes wherein the device is preceded by solids removal.

Solids removal can be used to as pretreatment where the wastewater influent stream has a solid component.

A further aspect of the present invention includes wherein the pretreatment includes settling, screening, filtration, or a combination thereof.

An additional aspect of the present invention includes wherein the device is preceded, followed, or a combination thereof, by solids removal.

Solids removal can be used as secondary clarification where the effluent stream is preferred to be free or substantially free of suspended solids.

An aspect of the present invention includes wherein the secondary clarification includes settling, screening, filtration, or a combination thereof.

Another aspect of the present invention includes wherein the device is a closed system and thereby can operate passively at, above, or below the influent hydraulic grade line.

A further aspect of the present invention includes wherein the wastewater enters and leaves the device by gravity.

An additional aspect of the present invention includes wherein the wastewater is pumped to and/or from the device.

An aspect of the present invention includes wherein a recirculation pump is used to supplement the convective recirculation rate through the device.

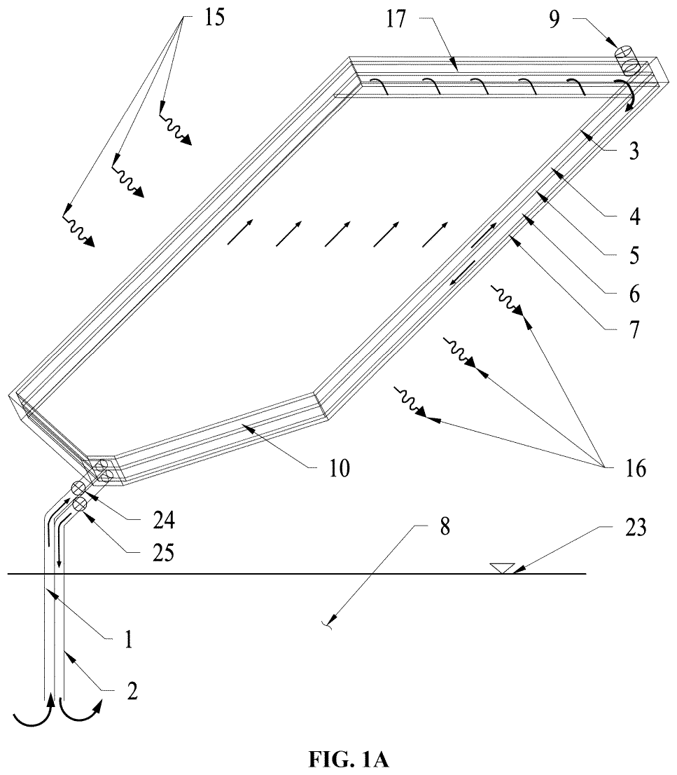

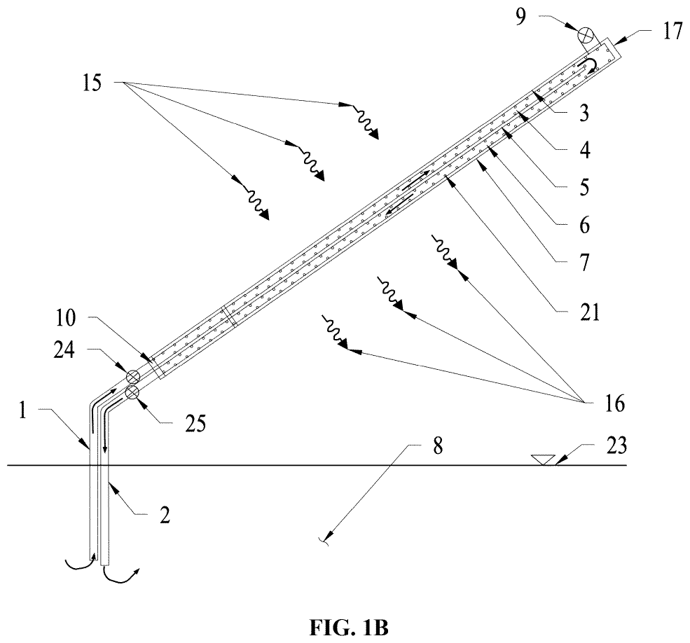

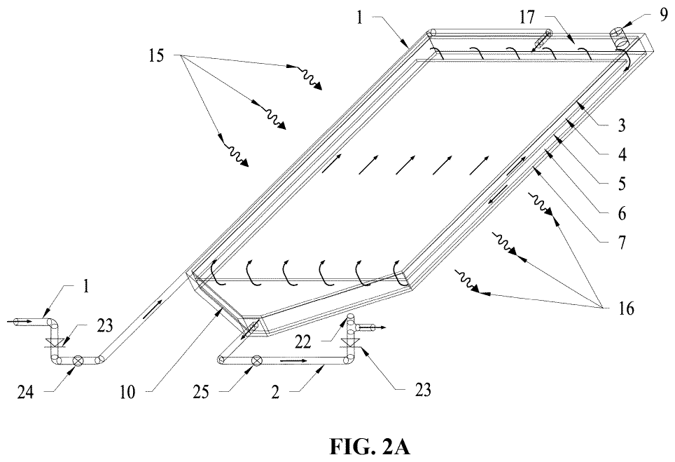

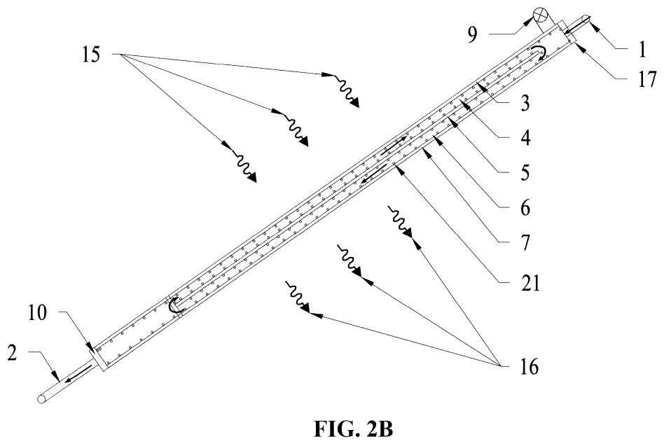

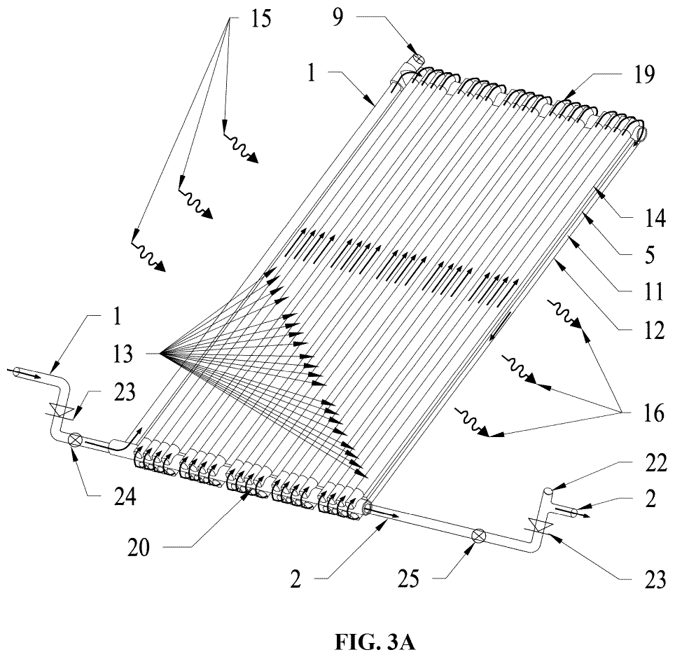

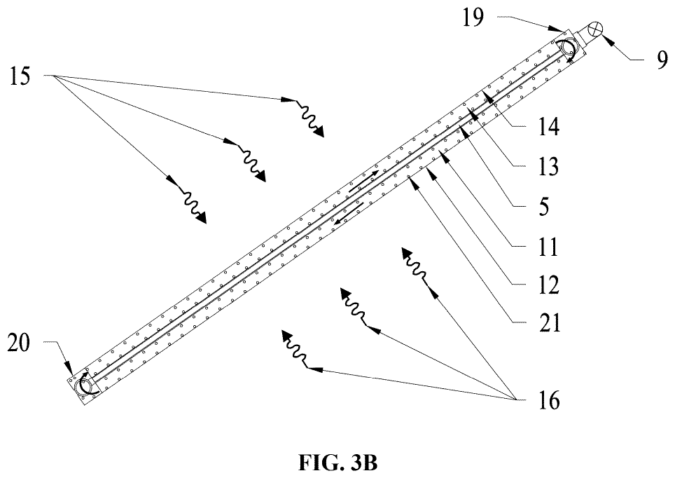

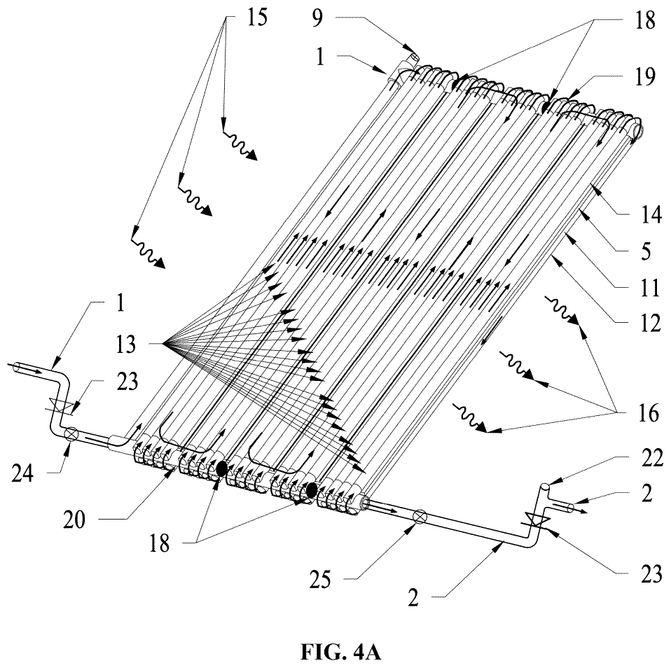

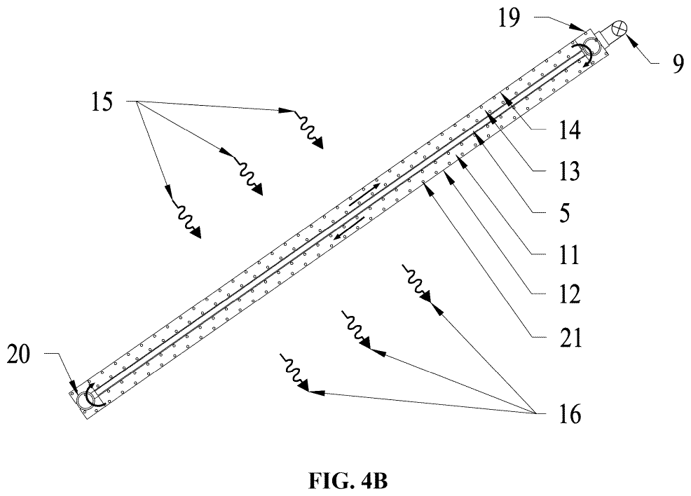

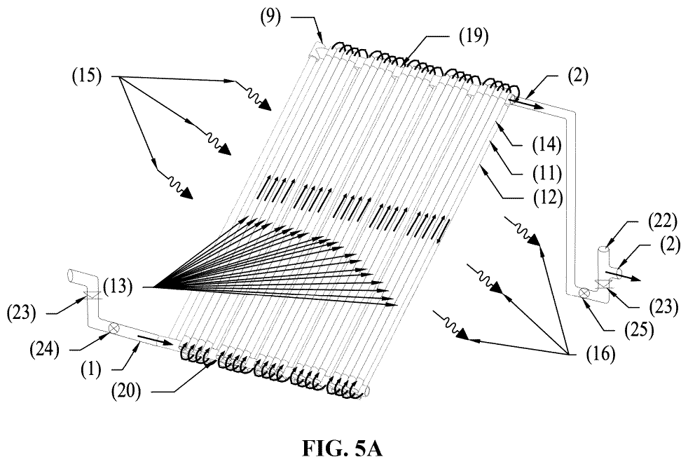

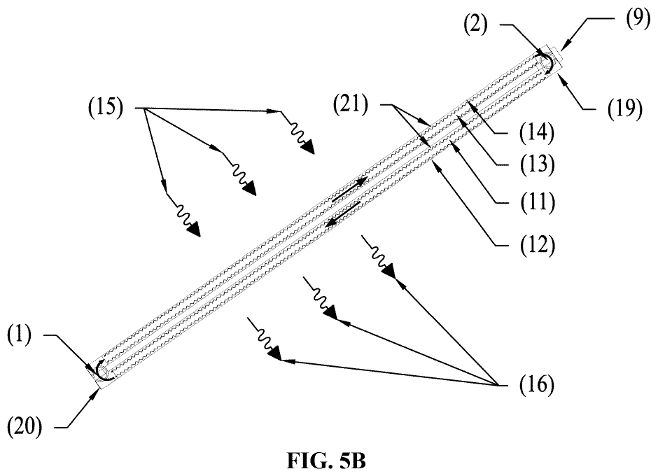

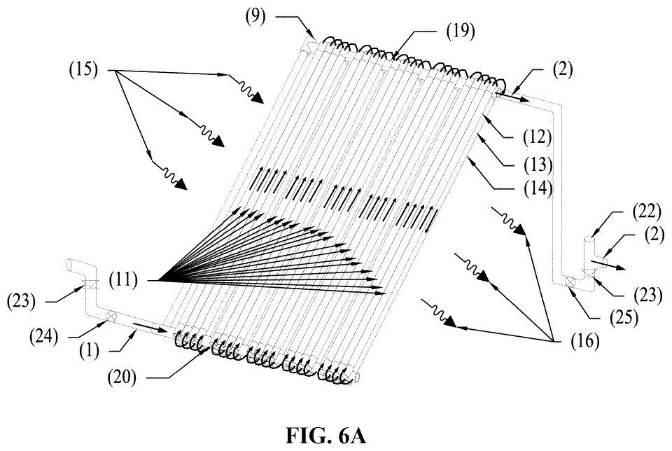

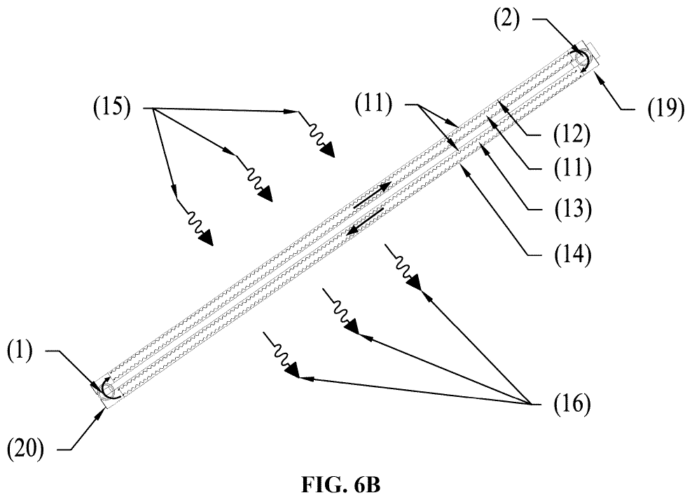

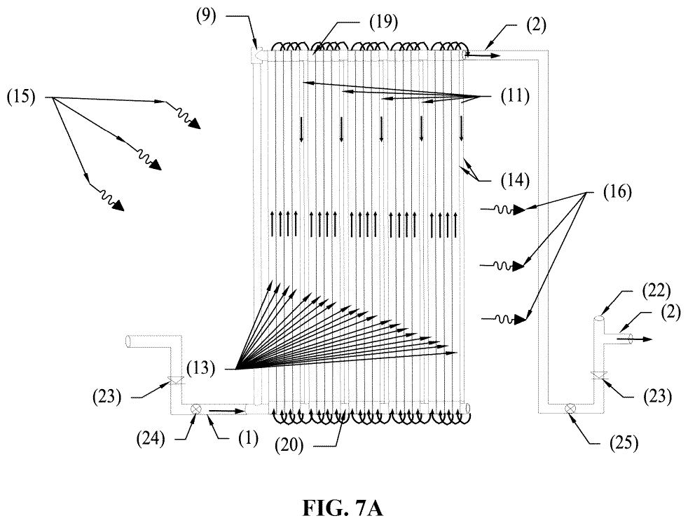

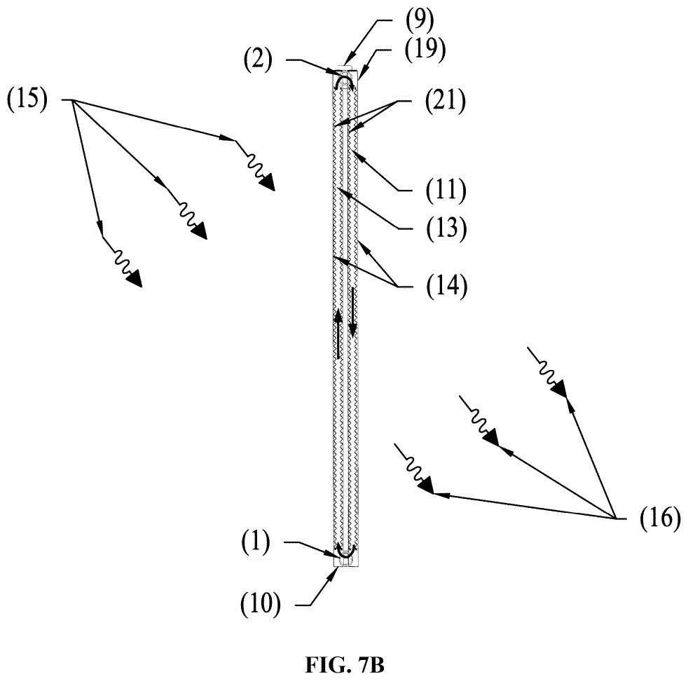

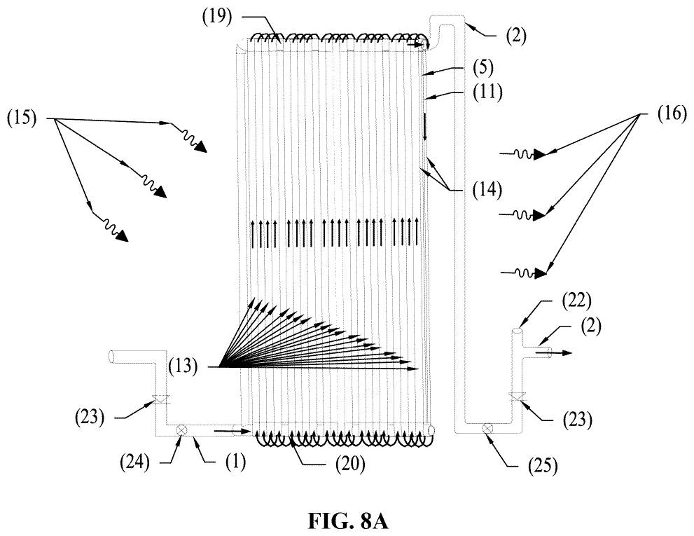

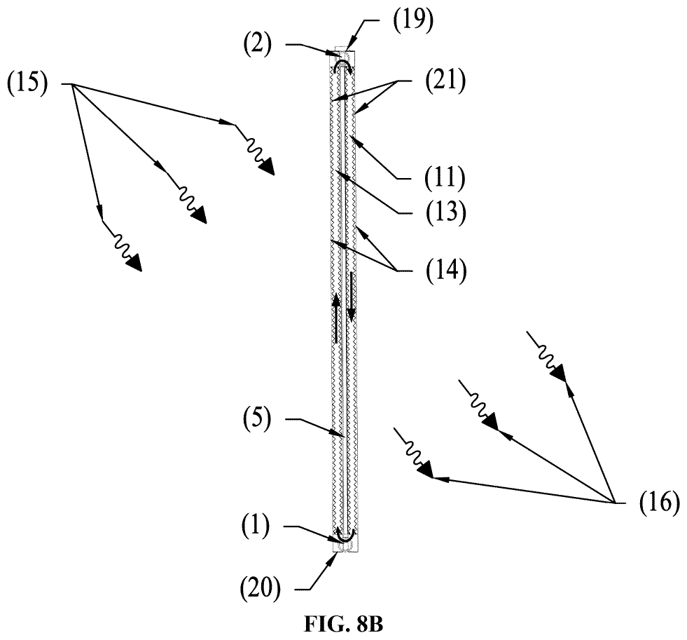

The Passive Aerobic Treatment Unit (PATU) of the present invention is generally a fixed film photobioreactor within which a microbiological community of autotrophic, heterotrophic, and mixotrophic organisms, or a combination thereof, is grown in a biofilm. Basic schematics of various configurations of the PATU are shown in FIG. 1A, FIG. 1B, FIG. 2A, FIG. 2B, FIG. 3A, FIG. 3B, FIG. 4A, FIG. 4B, FIG. 5A, FIG. 5B, FIG. 6A, FIG. 6B, FIG. 7A, FIG. 7B, FIG. 8A, and FIG. 8B. The PATU can include a thin, sealed container with a transparent at least intermittently illuminated conduit (4) or conduits (13), an at least intermittently shaded conduit (6) or conduits (11) and an optional parallel divider plate (5) that separates the ascending illuminated conduit(s) and descending shaded conduit(s). The width of a single PATU can be about 5 mm to about 2000 mm but can be expanded by adding multiple PATU's in series or in parallel. The length of a single PATU can be about 100 mm to about 4000 mm but can be expanded by adding multiple PATU's in series or in parallel. The illuminated conduit(s) are oriented on an angle from the horizontal and can be a flat conduit (4) bounded by the optional parallel divider plate (5) from below and a transparent top face (3) from above or it can be a series of conduits (13) comprised of transparent pipe material (14). The depth of the illuminated conduit(s) can vary from about 1 mm to about 150 mm to limit the length of the light path through water. The shaded conduit can be a flat conduit (6) bounded by the parallel divider plate (5) from above and an opaque back face (7) from below or it can be a series of conduits (12) comprised of opaque heat exchange material (13) designed to maximize convective heat exchange with the outside environment and shade the shaded conduit(s). In both cases, an optional divider plate (5) can be used to assist in shading the shaded conduit (6) or conduits (11) from incident radiation (15).

Alternatively, the shaded conduit can be a flat conduit bounded by the optional parallel divider plate (5) and a transparent top face (3) or it can be a shaded series of conduits (11) comprised of transparent pipe material (14) designed to admit incident radiation similar to the at least intermittently illuminated conduit(s). The at least intermittently illuminated conduit(s) (13) can be used to shade the at least intermittently shaded series of conduits (11) for the first half of the day while the at least intermittently shaded conduits (11) can shade the at least intermittently illuminated conduit(s) (13) for the second half of the day when the sun has shifted position. Alternatively, an optional divider plate (5) can be used to alternately shade the at least intermittently shaded conduit(s) (11) and at least intermittently illuminated conduit(s) (13) at different times.

The depth of the at least intermittently shaded conduit(s) can vary from about 1 mm to about 3000 mm, with those larger depths being used as integrated storage to increase hydraulic retention time.

The at least intermittently illuminated conduit(s) meet the at least intermittently shaded conduit(s) at the upper end wall (17) or upper manifold (19) and at the lower end wall (10) or lower manifold (20) or via a settling chamber (8) preferably located below the PATU. The upper manifold (19) and lower manifold (20) can vary from about 5 to 2000 mm long. The volume of the upper manifold (19) and lower manifold (20) can vary from about 100 mL to 1000 L each. The upper manifold (19) and lower manifold (20) can be any material stable in water that is sufficient rigid to join the at least intermittently illuminated conduit(s) and the at least intermittently shaded conduit(s). This can include but is not limited to black steel, copper, aluminum, glass, fiberglass, PVC, ABS, CPVC, polyethylene, and acrylic.

The transparent top face (3) or transparent pipe material (14) can be any transparent or translucent material that will allow the passage of incident radiation into the illuminated conduit(s) (4) and optionally the shaded conduit(s) (6) and provide structural support while optimizing internal temperature, recirculation rate, and photoactive radiation levels for algal and bacterial growth. This can include but is not limited to acrylic, polyethylene, polycarbonate, clear PVC, GFRP, or glass. The transparent top face (3) or transparent pipe material (14) can also be sufficiently rough to allow the attachment of a biofilm (21). The transparent face (3) or transparent pipe material (14) can be about 0.1 mm to about 100 mm thick. The optional divider plate (5) can include any opaque material that is sufficiently insulative to prevent the conduction of heat from the water in the illuminated conduit (4) or conduits (13) to the water in the shaded conduit (6) or conduits (11). The optional divider plate (5) can be reflective or absorptive in nature to control the amount of radiation energy absorbed into the water in the illuminated conduit (4) or conduits (13) or optionally, the water in the shaded conduit (6) or conduits (11). The optional divider plate (5) can be about 1 mm to about 2,000 mm thick. The optional opaque back face (7) or heat exchange material (12) can be any opaque and sufficiently thermally conductive and/or thin material to facilitate heat exchange with the outside environment (16) from or to the water in the shaded conduit (6) or conduits (11). This can include but is not limited to black steel, copper, aluminum, fiberglass, PVC, ABS, CPVC, polyethylene, and acrylic. The optional opaque back face (7) or heat exchange material (12) can also be sufficiently rough to allow the attachment of a biofilm (21). The optional opaque back face (7) or heat exchange material (12) can be about 0.1 mm to about 100 mm thick. The optional gas relief valve (9) is a valve situated at the highest point of the PATU that can facilitate the removal of any gases that can collect at the upper end wall (17) or upper manifold (19) of the PATU, either by pump if the gas relief valve (9) is above the hydraulic grade line (23) or by gravity if the gas relief valve (9) is below the hydraulic grade line (23), or a combination thereof. The optional gas relief valve (9) may have an internal diameter of about 0.1 mm to about 350 mm. Baffles (18) can be used to prevent hydraulic short circuiting however the baffles in the upper manifold (19) preferably have holes to allow collected gases to traverse the upper manifold (19) to an outlet port (2) or optional gas relief valve (9). The baffles can preferably be sized to have the same cross-sectional area as the upper manifold (19).

The PATU can be mounted above a water body, reactor tank, or settling chamber (8), or it can be operated in-line with the influent (1) and effluent (2) lines above, at, or below their hydraulic grade line (23), or a combination thereof. If operated in-line with the influent (1) and effluent (2) lines, a syphon break (22) can be provided following the PATU to prevent the PATU from completely draining to the effluent line (2). The influent and effluent lines can have an internal diameter of about 1 mm to about 350 mm. An inlet valve (24) and outlet valve (25) are provided to facilitate filling and inoculation.

FIG. 1A and FIG. 1B presents an illustration of a PATU installed in conjunction with a settling chamber (8), septic tank, or body of water. The influent line (1) of the PATU runs up from below the hydraulic grade line (23) of the settling chamber (8). The influent line (1) passes through an inlet valve (24) and connects to the PATU via a bulkhead connection in the lower end wall (10) at the base of the at least intermittently illuminated conduit (4). Similarly, the effluent line (2) of the PATU runs down from the lower end wall (10) at the base of the shaded conduit (6), through an outlet valve (25), to below the hydraulic grade line (23) of the settling chamber (8). The at least intermittently illuminated conduit (4) and the shaded conduit (6) merge at the upper end of the PATU through a gap between the divider plate (5) and the upper end wall (17). The illuminated conduit (4) has a transparent face (3) that admits incident radiation (15) and exchange heat with the outside environment. The shaded conduit (6) can have an opaque back face (7) to exchange heat with the outside environment (16). Prior to operation, gas is removed from the PATU using the gas relief valve (9), thus filling it with water and creating an unbroken hydraulic circuit from the settling chamber (8), up through the influent line (1) into the PATU, around the PATU, and back down the effluent line (2) into the settling chamber (8). A biofilm (21) coats the interior surfaces of the PATU.

FIG. 2A and FIG. 2B presents an illustration of a PATU operating in-line with the influent (1) and effluent (2) lines without a settling chamber. In this configuration, the influent line (1) passes through the inlet valve (24) and enters the PATU at the upper end wall (17) and the effluent line (2) leaves the PATU at the lower end wall (10) and passes through the outlet valve (25). The effluent line (2) contains a siphon break (22) above the hydraulic grade line (23) that prevents the PATU from draining with the effluent. The at least intermittently illuminated conduit (4) and the shaded conduit (6) are connected both at the upper end of the PATU, through a gap between the divider plate (5) and the upper end wall (17), and at the lower end of the PATU, through a gap between the divider plate (5) and the lower end wall (10). The at least intermittently illuminated conduit (4) can have a transparent face (3) that admits incident radiation (15) and exchanges heat with the outside environment. The shaded conduit (6) has an opaque back face (7) to exchange heat with the outside environment (16). Prior to operation, the PATU is filled with water, creating an unbroken hydraulic circuit between the at least intermittently illuminated conduit (4) and the shaded conduit (6) within the PATU. A biofilm (21) coats the interior surfaces of the PATU. Gases that collect within the PATU can be removed via the gas relief valve (9).

FIG. 3A and FIG. 3B also presents an illustration of a PATU operating in-line with the influent (1) and effluent (2) lines without a settling chamber. However, in this configuration the illuminated conduit is comprised of a series of parallel illuminated conduits (13) made of transparent pipe material (14) that can at least intermittently admit incident radiation (15) and exchange heat with the outside environment. Additionally, the shaded conduit is comprised of a shaded series of conduits (11) made from heat exchange pipe material (12) designed to maximize heat exchange (16) from the water in the shaded conduits (11) to the outside environment based on an increase in convective and radiative surface area relative to the rectangular conduit design. The at least intermittently illuminated conduits (13) and shaded conduits (11) are joined at the upper manifold (19) and lower manifold (20). The manifolds can be increased in size in order to increase system volume as an integrated tank. The at least intermittently illuminated conduits (13) and shaded conduits (11) are thermally separated by a divider plate (5). A biofilm (21) coats at least a portion of the interior surfaces of the PATU. This modification can also be made to the system operating in conjunction with a septic tank shown in FIG. 1A and FIG. 1B.

FIG. 4A and FIG. 4B also presents an illustration of a PATU operating in-line with the influent (1) and effluent (2) lines without a settling chamber. However, in this configuration the PATU is designed with baffles (18) that prevent hydraulic short-circuiting. The influent line (1) line can also be connected at the lower manifold (20) of the PATU.

FIG. 5A and FIG. 5B also presents an illustration of an in-line PATU in which the at least intermittently illuminated conduit is comprised of an illuminated series of conduits (13) made of transparent pipe material (14) and the shaded conduit is comprised of a shaded series of conduits (11) made from heat exchange pipe material (12). However, in this configuration there is no divider plate (5) and the outlet (2) is located at the top of the PATU.

FIG. 6A and FIG. 6B also presents an illustration of an in-line PATU without a divider plate (5) in which the at least intermittently illuminated conduit is comprised of an illuminated series of conduits (13) made of transparent pipe material (14) and the shaded conduit is comprised of a shaded series of conduits (11) made from heat exchange pipe material (12). However, in this configuration the shaded conduits (11) are situated between the at least intermittently illuminated conduits (13) and the incident radiation (15) in order to partially shield the at least intermittently illuminated conduits from excess radiation.

FIG. 7A and FIG. 7B also presents an illustration of an in-line PATU without a divider plate (5) in which the at least intermittently illuminated conduit is comprised of an illuminated series of conduits (13) made of transparent pipe material (14) and the at least intermittently shaded conduit is comprised of a shaded series of conduits (11). However, in this configuration the series of shaded conduit(s) (11) are made from transparent pipe material (14). The PATU is installed generally vertically with the two faces preferably oriented generally in the East-West direction such one of the at least intermittently illuminated conduits and the at least intermittently shaded conduits is preferentially illuminated at a time while the other exists in the shadow of the first.

FIG. 8A and FIG. 8B also presents an illustration of an in-line PATU in which the at least intermittently illuminated conduit is comprised of an illuminated series of conduits (13) made of transparent pipe material (14) and the at least intermittently shaded conduit includes a shaded series of conduits (13) made of transparent pipe material (14). However, in this configuration there is a divider plate (5) that assists in preferentially shading the series of conduits opposite the source of incident radiation (15).

If the PATU is installed as a skylight or window between two environments, the temperature difference between the two environments can be used to encourage convective recirculation, with the PATU acting as a heat pump, absorbing heat from one environment and releasing it into the second. In this case, the transparent top face (3) or transparent pipe material (13) can be made to be less insulative to increase heat exchange between the illuminated conduit (4) or series of conduits (13) and the outside environment.

The PATU can be first inoculated with a live culture of the desired autotrophic, phototrophic, chemotrophic, heterotrophic, and mixotrophic organisms in a number of ways and sources of culture (for example, lab grown, naturally sources, a combination thereof, or as known in the art). The live culture can be introduced in a powder, liquid, or solid form. It can be introduced in suspension or on the surface of a physical media. It can be accompanied by wastewater or other growth solution. It can be released all at once or via a time release mechanism. Wastewater can be introduced immediately following inoculation or a delay can be used to allow biofilm attachment within the PATU.

### II. Method of Treatment of Wastewater Using a Device of the Present Invention

A second aspect of the present invention includes a method of treating wastewater, including: a) providing at least one device of the present invention; b) operably engaging the at least one device of the present invention with at least one source of wastewater to be treated; c) operating the at least one device of the present invention with the at least one source of wastewater; wherein the wastewater is treated.

The at least one device of the present invention can be initiated by opening the inlet valve and opening an outlet or gas relief valve or gas relief pump situated at the top of the PATU. Water can then flow by gravity or be pumped into the device until the device is filled with water. Once filled, any outlet located at the bottom of the PATU can then be opened as well for normal operation. The optional gas relief valve can be set to open when the water level in the device falls below a threshold level in order to remove gas build up before the convective loop within the device is broken. Alternatively, gas can be allowed to collect at a liquid outlet located at the top of the PATU and be evacuated with effluent flows. Inoculation of the device can include any procedure for seeding the desired microorganisms on the internal walls of the device. The inoculation procedure can include one of a) suspending a live culture of the desired microbes in wastewater or growth media within the device for an extended period prior to use; b) snaking the device with a brush coated in a live culture of the desired microbes prior to use; c) installing a fitting already populated with a live culture of the desired microbes on the influent line of the device prior to use; d) introducing a live culture of the desired microbes to the device via the influent line during use; e) any combination thereof.

### Wastewater

In an aspect of the present invention, wherein the wastewater comprises sewage, cistern waste, household waste, municipal waste, industrial waste, animal waste, digestate, leachate, farm waste, run-off, a polluted water body, or a combination thereof.

In another aspect of the present invention, the wastewater is untreated, partially treated, fully treated, or a combination thereof.

Operation of the PATU can include light of natural or non-natural origin provided on a continuous or intermittent basis, and an influent stream containing essential nutrients and a carbon source, such as but not limited to sewage and industrial waste. The PATU can operate at thermophilic, mesophilic, or psychrophilic temperatures. Influent can be pumped through the PATU, rise up from a settling chamber via convection, or it can flow passively by gravity as the production of wastewater causes the hydraulic head at the inlet to increase relative to the hydraulic head at the outlet. As the PATU is a closed photobioreactor, it can be situated above or below the influent water's hydraulic grade line, independent of whether the influent feed is pumped or gravity fed. When the PATU is installed above the hydraulic grade line of the influent water source, the pressure inside the PATU can be below atmospheric pressure. This negative pressure environment can be used to strip dissolved gases from the system by removing separated gases via the gas relief valve (9) at the top of the PATU, either by pump if the gas relief valve (9) is above the hydraulic grade line (23) or by gravity if the gas relief valve (9) is below the hydraulic grade line (23).

In a configuration including an at least intermittently illuminated conduit (4) or series of conduits (13) made of transparent pipe material (14) and a shaded conduit (6) or series of conduits (11) made of heat exchange pipe material (12), the PATU can be designed to maximize thermal gain into illuminated conduit(s) and maximize thermal losses from the shaded conduit(s) to the extent that it encourages passive, convective recirculation between the two conduits and facilitates the growth of biomass. The water heats in the at least intermittently illuminated conduit (4) or conduits (13) as a result of at least intermittent incident radiation (15), becomes less dense relative to the water in the shaded conduit (6) or conduits (11), and rises to the upper end of the at least intermittently illuminated conduit (4) or conduits (13). At the upper end wall (17) the water then flows around into the shaded conduit (6) or conduits (11) where it cools as a result of heat exchange (16) with the outside environment. The water now becomes more dense relative to the water in the at least intermittently illuminated conduit (4) or conduits (13), and falls to the lower end of the PATU. Water can then recirculate back to the at least intermittently illuminated conduit (4) or conduits (13), either directly or after passing through a settling chamber.

In a configuration including an at least intermittently illuminated conduit (4) or series of conduits (13) made of transparent pipe material (14) and an at least intermittently shaded conduit (6) or series of conduits (11) also made of transparent pipe material (14), the PATU can be designed to optimize thermal gains and thermal losses from the at least intermittently illuminated conduit(s) and the at least intermittently shaded conduit(s) to the extent that it encourages passive, convective recirculation between the two conduits and facilitates the growth and activity of biomass. The PATU can be preferably installed in a generally East-West orientation such that either the at least intermittently illuminated conduit(s) or at least intermittently shaded conduit(s) are preferentially illuminated at a time. In the morning, the water heats in the at least intermittently illuminated series of conduits (13) exposed to incident radiation (15) while the water in the at least intermittently shaded series of conduits (11) cools in the shadow of the at least intermittently illuminated series of conduits (13). Water in the at least intermittently illuminated series of conduits (13) becomes less dense relative to the water in the at least intermittently shaded series of conduits (11), and rises to the upper end of PATU. At the upper manifold (19) the water then flows around into the at least intermittently shaded series of conduits (11) where it cools as a result of heat exchange (16) with the outside environment. The water now becomes more dense relative to the water in the at least intermittently illuminated conduit series of conduits (13), and falls to the lower end of the PATU. Water can then recirculate back to the at least intermittently illuminated series of conduits (13). This process may then reverse at midday when the at least intermittently shaded series of conduits (11), also made from transparent pipe material (14) is exposed to incident radiation (15) while the at least intermittently illuminated series of conduits (13) exists in their shadow.

Recirculation improves the kinetic rates of microbiological processes taking place in the biofilm, including photosynthesis, respiration, growth, nitrification, denitrification etc. The biofilm (21) that can develop in the at least intermittently illuminated conduit (4) or conduits (13) can contain photosynthetic microbes to at least intermittently create an oxygen rich environment that encourages nitrification, respiration, and other aerobic processes. The biofilm (21) that can develop in the at least intermittently shaded conduit (6) or conduits (11) can be more biased towards anoxic treatment processes such as denitrification or it can be likewise contain photosynthetic microbes to create an intermittent oxygen rich environment that encourages nitrification, respiration, and other aerobic processes. This recirculation of wastewater between aerobic and anoxic biofilms can create optimal conditions for biological nutrient removal. Without sunlight driving recirculation at night, the convective recirculation rate can slow as the water in the PATU comes into equilibrium with temperatures in the outside environment. A difference in the relative thermal conductivity of the illuminated conduit (4) or conduits (13) and the shaded conduit (6) or conduits (11) can be used to induce recirculation in the forward or backwards direction as the water in the panel comes into equilibrium with temperatures in the outside environment.

The growth and biological processes of the biofilm on the internal surfaces of the PATU removes a fraction of the of the soluble nutrients and dissolved carbon from the influent stream to produce biomass. This biomass naturally sloughs from the surface as it ages and can be made to leave the PATU with an effluent that is now deficient in dissolved nutrients and organics and rich in suspended biomass. The biomass can subsequently be separated from the effluent through settling, screening, filtration, or other solids separation techniques, or it can be left in the effluent to be applied to the land as fertilizer using a solids friendly distribution process. Alternatively, placing the outlet structure at the top of the panel and/or using baffling to induce settling of sloughed biofilm can be done to encourage the retention of sloughed solids within the panel, to maximize gas production and minimize effluent solids. The microbes that populate the biofilm can be autotrophic, heterotrophic, or mixotrophic organisms, or a combination thereof.

Known genera of nitrifying bacteria that can be cultivated in the PATU to facilitate the conversion of Ammonia to Nitrate under oxic conditions include but are not limited to: Nitrobacter, Nitrococcus, Nitrosococcus, Nitrosomonas, Nitrosovibrio, Nitrospina, Nitrospira, and SM1A02. Known species of nitrifying bacteria the can be cultivated in the PATU include but are not limited to: Nitrobacter alkalicus, Nitrobacter hamburgensis, Nitrobacter vulgaris, Nitrobacter winogradskyi, Nitrococcus mobilis, Nitrosococcus nitrosus, Nitrosomonas aestuarii, Nitrosomonas cryotolerans, Nitrosomonas communis, Nitrosomonas europaca, Nitrosomonas cutropha, Nitrosomonas halophila, Nitrosomonas marina, Nitrosomonas mobilis, Nitrosomonas nitrosa, Nitrosomonas oligotropha, Nitrosomonas stercoris, Nitrosomonas ureae, and Nitrospira inopinata.

The list of denitrifying bacteria known to populate wastewater treatment systems that are appropriate for cultivation in the PATU to convert Nitrate to Nitrogen gas under anoxic conditions is far more diverse and includes over 50 genera, some of which include but are not limited to: Achromobacter, Acromonas, Alcaligenes, Bacillus, Dechloromonas, Flavobacterium, Haliangium, Micrococcus, Oligotropha, Paracoccus, Pseudomonas, Rhodoferax, Serratia, Sulfurtalea, Thauera, Thermomonas, Thiobacillus, and Zoogloca. Other heterotrophic and autotrophic bacteria that can be cultivated in the PATU is long and includes but is not limited to species of the genera: Acinetobacter, Alcaligenes, Alicycliphilus, Alsobacter, Akkermansia, Bauldia, Blastocatella, Brevibacterium, Brevifollis, Brevundimonas, Bryobacter, Caldininea, Calothrix, Candidatus Accumulibacter, Arenimonas, Caulobacter, Chryscobacterium, Cloacibacterium, Clostridium, Comomonas, Cytophage, Defluviimonas, Dinhuibacter, Dokdonella, Duganella, Ferruginibacter, Fimbriiglobus, Flavihumibacter, Flavobacterium, Haliangium, Hirschia, Holophaga, Hyphomicrobium, Janthinobacterium, Kaistia, Lactobacillus, Lactococcus, Leptospira, Luteibacter, Mesorhizobium, Methylorosula, Microbacterium, Mycobacterium, Niabella, Novosphingobium, Paracacdibacter, Paucibacter, Pedobacter, Polaromonas, Propionivibrio, Pseudomonas, Pseudolabrys, Ralstonia, Reyranella, Rhodanobacter, Rhizobacter, Rudaca, Simplicipira, Sphacrotilus, Sphingopyxis, Tabrizicola, Turneriella, Undibacterium, Woodsholea, and Yersinia.

Known genera of photosynthesizing microbes to be cultivated in the PATU to facilitate the uptake of nutrients and aerate the system through photosynthesis are also diverse and includes but is not limited to species of the genera: Bacillariophyta, Characium, Chlamydomonas, Chlorella, Desmodesmus, Dunaliella, Euglena, Haematococcus, Navicula, Nitzschia, Oocystis, Oscillatoria, Pichochlorum, Pseudocharaciopsis, Scenedesmus, Stigeoclonium, and Tychonema. Chlorella Sorokiniana has been identified as a particularly viable species of algae in the low thermophilic range in which the PATU can operate. Other species of photosynthesizing microbes to be cultivated in the PATU includes but is not limited to the species: Anabaena augstmalis, Botryococcus braunii, Chlorella minutissima, Chlorella sorokiniana, Chlorella vulgaris, Phormidium autumnale, Scenedesmus acutus, Scenedesmus quadricauda, Scenedesmus obliquus, Synechocystis aquatilis, and Trichormus variabilis. Additional microbes known to remove organics, nutrients, and other contaminants of emerging concern such as per- and polyfluoroalkyl substances can also be cultivated in the PATU.

### EXAMPLES

### Example 1: PATU Installation in Conjunction with a Settling Chamber

This example establishes the operation of a PATU in conjunction with a settling chamber (8), septic tank, or body of water, as illustrated in FIG. 1A and FIG. 1B.

Untreated wastewater enters the settling chamber (8) at one end and treated water leaves the disposal line at the other end. An influent line (1) rises from the center of the settling chamber (8) to the base of the at least intermittently illuminated conduit (4) of the PATU above. An effluent line (2) descends from the base of the shaded conduit (6) of the PATU to the center of the settling chamber (8). Prior to operation, the PATU is filled with water, creating an unbroken hydraulic circuit from the settling chamber (8), up through the influent line (1) into the PATU, around the PATU, and back down the effluent line (2) into the settling chamber (8). As water heats in the at least intermittently illuminated conduit (4) as a result of incident radiation (15), the water becomes less dense relative to the water in the shaded conduit (6). This causes the water in the at least intermittently illuminated conduit (4) to rise to the top of the PATU and flow into the shaded conduit (6) through a gap between the divider plate (5) and the upper end wall (17). This flow simultaneously draws water up from the settling chamber (8) and into the at least intermittently illuminated conduit (4) behind it. Meanwhile, water in the shaded conduit (6) cools as a result of heat exchange with the outside environment (16) and becomes more dense relative to the water in the at least intermittently illuminated conduit (6). This causes it to descend down the shaded conduit (6), through the effluent pipe (2) and back into the settling chamber (8), thus completing the convective loop. Any biofilm that sloughed from the inside surfaces of the PATU is carried with the flow down into the settling chamber (8) to settle. Several PATU's can be connected separately or in parallel to the settling chamber (8). The cumulative PATU volume can be sized to provide a minimum average hydraulic retention time inside the PATU's for all wastewater passing through the system. In environments where the convective recirculation rate is insufficient to transport sloughed biofilm through the PATU and/or recycle the contents of the settling chamber (8) through the PATU sufficiently quickly, a recirculation pump can be added to the influent or effluent line to speed recirculation. In the event that a recirculation pump is used, multiple PATU's can be connected in series before connecting back to the settling chamber (8).

The PATU can be first inoculated with a live culture of the desired autotrophic, phototrophic, chemotrophic, heterotrophic, and mixotrophic organisms in a number of ways that can be used alone or in combination, including but not limited to:
(a) filling the PATU with a live culture of the desired microbes suspended in wastewater or growth media and allowing the system to sit with the inlet valve (24) and outlet valve (25) closed without additional influent for two days prior to use;
(b) snaking the PATU with a brush coated a live culture of the desired microbes through the influent line (1) to directly seed the interior walls of the PATU with the desired microbes prior to use;
(c) installing a fitting on the influent line (1) of the PATU already populated with a live culture of the desired microbes prior to use; and
(d) introducing a dried or fresh live culture of the desired microbes to the system via a household water fixture during use.

To initiate operation, the hydraulic circuit through the PATU is preferably filled with water. This can be done by opening the inlet valve (24) and outlet valve (25) and opening the gas relief valve (9). The gas relief valve (9) should be set to release gases from the top of the PATU whenever a maximum level of gas is detected inside the PATU in order to maintain the hydraulic circuit. This can be done using a pump as the gas relief valve (9) is above the hydraulic grade line (23). The inlet valve (24) and outlet valve (25) should be left open during operation.

### Example 2: PATU Installation In-Line

This example establishes the operation of a PATU in-line with the influent (1) and effluent (2) lines without a settling chamber, as illustrated in FIG. 2A and FIG. 2B.

In this configuration, the influent line (1) enters the PATU at the upper end wall (17) and the effluent line (2) leaves the PATU at the lower end wall (10). An increase in hydraulic head at the inlet relative to the outlet causes pretreated wastewater to flow into the PATU via the influent pipe (1) and treated effluent to flow out via the effluent pipe (2). Inside the PATU, water continuously recirculates between the at least intermittently illuminated conduit (4) and shaded conduit (6) during the day. The water heats in the at least intermittently illuminated conduit (4) as a result of incident radiation (15) and becomes less dense relative to the water in the shaded conduit (6). This causes the water to rise to the upper end of the at least intermittently illuminated conduit (4). At the upper end of the at least intermittently illuminated conduit (4), the water then flows around into the shaded conduit (6) through a gap between the divider plate (5) and the upper end wall (17). The water cools in the shaded conduit (6) as a result of heat exchange with the outside environment (16) and becomes more dense relative to the water in the at least intermittently illuminated conduit (4). This causes the water to fall to the lower end of the shaded conduit (6). At the lower end of the shaded conduit (6), the water then flows back around into the at least intermittently illuminated conduit (4) through a gap between the divider plate (5) and the lower end wall (10). The water recirculates between the at least intermittently illuminated (4) and shaded (6) conduits indefinitely until new influent enters the PATU and forces water out through the effluent line (2). Sloughed biofilm collects at the base of the lower end wall (10) as a result of its sloped geometry and is carried out with the effluent. A siphon break (22) can be positioned along the effluent line (2) and above the hydraulic grade line (23) to prevent the entire PATU volume from draining with the effluent. Before and after the PATU, the influent and effluent can undergo settling, screening, filtration, or other solids separation techniques. An example of this is the installation of the PATU to treat the leachate from a Sun-Mar Centrex composter. The composter strains out fecal solids and the liquid blackwater leachate can then be used as influent for the PATU. Similarly, a food waste solids interceptor can be installed on a kitchen wastewater line to strain out solids prior to treatment with the PATU. In onsite residential wastewater treatment applications, the PATU can be used to treat mixed wastewater streams, grey water streams, or blackwater streams. Multiple PATU's can be installed in parallel or in series. The cumulative PATU volume can be sized to provide a minimum average hydraulic retention time. In environments where the convective recirculation rate is limiting process kinetics, a recirculation pump or turbine can be added to each PATU.

The PATU can be first inoculated with a live culture of the desired autotrophic, phototrophic, chemotrophic, heterotrophic, and mixotrophic organisms in a number of ways that can be used alone or in combination, including but not limited to:
(a) filling the PATU with a live culture of the desired microbes suspended in wastewater or growth media and allowing the system to sit with the inlet valve (24) and outlet valve (25) closed without additional influent for two days prior to use;
(b) snaking the PATU with a brush coated a live culture of the desired microbes through the influent line (1) to directly seed the interior walls of the PATU with the desired microbes prior to use;
(c) installing a fitting on the influent line (1) of the PATU already populated with a live culture of the desired microbes prior to use; and
(d) introducing a dried or fresh live culture of the desired microbes to the system via a household water fixture during use.

To initiate operation, the hydraulic circuit through the PATU is preferably filled with water. This can be done by initiating a wastewater flow to the PATU, opening the inlet valve (24), closing the outlet valve (25), and opening the gas relief valve (9). The gas relief valve (9) should be set to release gases from the top of the PATU whenever a maximum level of gas is detected inside the PATU in order to maintain the hydraulic circuit. Gas can be removed either by pump if the gas relief valve (9) is above the hydraulic grade line (23) or by gravity if the gas relief valve (9) is below the hydraulic grade line (23). The gas relief valve (9) should be set to close when the PATU is completely filled with water. Once the PATU is completely filled, the inlet valve (24) and outlet valve (25) should be left open during operation.

### Example 3: PATU Installation In-Line with an at Least Intermittently Illuminated Series of Conduits and a Shaded Series of Conduits Optionally with at Least One Divider Plate

This example establishes the operation of a PATU in-line with the influent (1) and effluent (2) lines and configured with an at least intermittently illuminated series of conduits and a shaded series of conduits, as illustrated in FIG. 3A and FIG. 3B.

In this configuration, the influent line (1) enters the PATU at the upper manifold (19) and the effluent line (2) leaves the PATU at the lower manifold (20). An increase in hydraulic head at the inlet relative to the outlet causes pretreated wastewater to flow into the PATU via the influent pipe (1) and treated effluent to flow out via the effluent pipe (2). Inside the PATU, water continuously recirculates between the at least intermittently illuminated series of conduits (13) and the shaded series of conduits (11) during the day. The water heats in the at least intermittently illuminated conduits (13) as a result of incident radiation (15) and becomes less dense relative to the water in the shaded conduits (11) that are shaded by the divider plate (5). This causes the water to rise to the upper end of the at least intermittently illuminated conduits (13). At the upper end of the at least intermittently illuminated conduits (13), the water flows through the upper manifold (19) and around into the shaded conduits (11). The water cools in the shaded conduits (11) as a result of heat exchange with the outside environment (16) and becomes more dense relative to the water in the at least intermittently illuminated conduits (13). This causes the water to fall to the lower end of the shaded conduits (11). At the lower end of the shaded conduits (11), the water then flows back around through the lower manifold (20) and into the at least intermittently illuminated conduits (13). The water recirculates between the at least intermittently illuminated conduits (13) and shaded (11) conduits indefinitely until new influent enters the PATU and forces water out through the effluent line (2). Sloughed biofilm settles at the base of the lower manifold (20) and is carried out with the effluent. A siphon break (22) can be positioned along the effluent line (2) and above the hydraulic grade line (23) to prevent the entire PATU volume from draining with the effluent. Before and after the PATU, the influent and effluent can undergo settling, screening, filtration, or other solids separation techniques. An example of this is the installation of the PATU to treat the leachate from a Sun-Mar Centrex composter. The composter strains out fecal solids and the liquid blackwater leachate can then be used as influent for the PATU. Similarly, a food waste solids interceptor can be installed on a kitchen wastewater line to strain out solids prior to treatment with the PATU. In onsite residential wastewater treatment applications, the PATU can be used to treat mixed wastewater streams, grey water streams, or blackwater streams. Multiple PATU's can be installed in parallel or in series. The cumulative PATU volume can be sized to provide a minimum average hydraulic retention time. In environments where the convective recirculation rate is limiting process kinetics, a recirculation pump or turbine can be added to each PATU.

The PATU can be inoculated with the desired microbes and operated in the same manner as in Example 2.

### Example 4: PATU Installation In-Line with an at Least Intermittently Illuminated Series of Conduits and Shaded Series of Conduits Equipped with Baffles

This example establishes the operation of a PATU in-line with the influent (1) and effluent (2) lines and configured with an at least intermittently illuminated series of conduits and shaded series of conduits that are baffled in groups to support convective recirculation while eliminating short circuiting, as illustrated in FIG. 4A and FIG. 4B.

In this configuration, the influent line (1) can enter the PATU at the upper manifold (19) or lower manifold (20) and the effluent line (2) leaves the PATU at the lower manifold (20). An increase in hydraulic head at the inlet relative to the outlet causes pretreated wastewater to flow into the PATU via the influent pipe (1), wind up and down through the PATU as permitted by the baffles (18), and treated effluent to flow out via the effluent pipe (2). Inside the PATU, water continuously recirculates within each grouping of at least intermittently illuminated conduits (13) and shaded conduits (11) during the day. The water heats in the at least intermittently illuminated conduits (13) as a result of incident radiation (15) and becomes less dense relative to the water in the shaded conduits (11). This causes the water to rise to the upper end of the at least intermittently illuminated conduits (13). At the upper end of the at least intermittently illuminated conduits (13), the water flows through the upper manifold (19) and around into the shaded conduits (11). The water cools in the shaded conduits (11) as a result of heat exchange with the outside environment (16) and becomes more dense relative to the water in the at least intermittently illuminated conduits (13). This causes the water to fall to the lower end of the shaded conduits (11). At the lower end of the shaded conduits (11), the water then flows back around through the lower manifold (20) and into the at least intermittently illuminated conduits (13). The water recirculates between the at least intermittently illuminated conduits (13) and shaded conduits (11) indefinitely until new influent enters the PATU and forces water out through the effluent line (2). A siphon break (22) can be positioned along the effluent line (2) and above the hydraulic grade line (23) to prevent the entire PATU volume from draining with the effluent. Large sloughed biofilms are retained to a greater degree in the panel as a result of the baffles, limiting suspended solids carried out with the effluent. Before and after the PATU, the influent and effluent can undergo settling, screening, filtration, or other solids separation techniques. Redox conditions can vary significantly along the flow path as nutrients and organics are oxidized.

The PATU can be inoculated with the desired microbes in the same manner as in Example 2.

To initiate operation, the hydraulic circuit through the PATU is preferably first be filled with water. This can be done by initiating a wastewater flow to the PATU, opening the inlet valve (24), closing the outlet valve (25) and opening the gas relief valve (9). The gas relief valve (9) should be set to release gases from the top of the PATU whenever a maximum level of gas is detected inside the PATU in order to maintain the hydraulic circuit. This can be done either by pump if the gas relief valve (9) is above the hydraulic grade line (23) or by gravity if the gas relief valve (9) is below the hydraulic grade line (23). The gas relief valve (9) should be set to close when the PATU is completely filled with water. Once the PATU is completely filled, the inlet valve (24) and outlet valve (25) should be left open during operation. In order to facilitate the removal of gases via the gas relief valve (9) during operation, gas holes should be made at the top of the baffles (18) in the upper manifold (19) that allow air to traverse the length of the upper manifold (19) to the gas relief valve (9).

### Example 5: PATU Installation In-Line with an at Least Intermittently Illuminated Series of Conduits and Shaded Series of Conduits without an at Least One Divider Plate

This example establishes the operation of a PATU in-line with the influent (1) and effluent (2) lines and configured with an at least intermittently illuminated series of conduits (13) made of transparent pipe material (14) and an at least intermittently shaded series of conduits (11) made from heat exchange pipe material (12) but without a divider plate (5), as illustrated in FIG. 5A and FIG. 5B.

In this configuration, the influent line (1) enters the PATU at the lower manifold (20) and the effluent line (2) leaves the PATU at the upper manifold (19). An increase in hydraulic head at the inlet relative to the outlet causes pretreated wastewater to flow into the PATU via the influent line (1) and treated effluent to flow out via the effluent line (2). Inside the PATU, water continuously recirculates between the at least intermittently illuminated series of conduits (13) and the shaded series of conduits (11) during the day. The water heats in the at least intermittently illuminated conduits (13) as a result of incident radiation (15) passing through the transparent pipe material (14) and becomes less dense relative to the water in the shaded conduits (11) that are shaded by the opaque heat exchange pipe material (12) and the profile of the at least intermittently illuminated conduits (13). This causes the water to rise to the upper end of the at least intermittently illuminated conduits (13). At the upper end of the at least intermittently illuminated conduits (13), the water flows through the upper manifold (19) and around into the shaded conduits (11). The water cools in the shaded conduits (11) as a result of heat exchange with the outside environment (16) and becomes more dense relative to the water in the at least intermittently illuminated conduits (13). This causes the water to fall to the lower end of the shaded conduits (11). At the lower end of the shaded conduits (11), the water then flows back around through the lower manifold (20) and into the at least intermittently illuminated conduits (13). The water recirculates between the at least intermittently illuminated conduits (13) and shaded conduits (11) indefinitely until new influent enters the PATU and forces water out through the effluent line (2). The effluent line (2) is connected to the upper manifold (19). Sloughed biofilm can be entrained in the system or carried out with the effluent. A siphon break (22) can be positioned along the effluent line (2) and above the hydraulic grade line (23) to prevent the entire PATU volume from draining with the effluent. Before and after the PATU, the influent and effluent can undergo settling, screening, filtration, or other solids separation techniques. An example of this is the installation of the PATU to treat the leachate from a Sun-Mar Centrex composter. The composter strains out fecal solids and the liquid blackwater leachate can then be used as influent for the PATU. Similarly, a food waste solids interceptor can be installed on a kitchen wastewater line to strain out solids prior to treatment with the PATU. In onsite residential wastewater treatment applications, the PATU can be used to treat mixed wastewater streams, grey water streams, or blackwater streams. Multiple PATU's can be installed in parallel or in series. The cumulative PATU volume can be sized to provide a minimum average hydraulic retention time. In environments where the convective recirculation rate is limiting process kinetics, a recirculation pump or turbine can be added to each PATU.

The PATU can be inoculated with the desired microbes and operated in the same manner as in Example 2.

### Example 6: PATU Installation In-Line with a Shaded Series of Conduits Overlaying an at Least Intermittently Illuminated Series of Conduits

This example establishes the operation of a PATU in-line with the influent (1) and effluent (2) lines and configured with a shaded series of conduits (11) made from heat exchange pipe material (12) overlaying an at least intermittently illuminated series of conduits (13) made of transparent pipe material (14) without a divider plate (5), as illustrated in FIG. 6A and FIG. 6B.

In this configuration, the influent line (1) enters the PATU at the lower manifold (20) and the effluent line (2) leaves the PATU at the upper manifold (19). An increase in hydraulic head at the inlet relative to the outlet causes pretreated wastewater to flow into the PATU via the influent line (1) and treated effluent to flow out via the effluent line (2). Inside the PATU, water continuously recirculates between the at least intermittently illuminated series of conduits (13) and the shaded series of conduits (11) during the day. The water heats in the at least intermittently illuminated conduits (13) as a result of incident radiation (15) passing through the transparent pipe material (14) and becomes less dense relative to the water in the shaded series of conduits (11). This causes the water to rise to the upper end of the at least intermittently illuminated conduits (13). At the upper end of the at least intermittently illuminated conduits (13), the water flows through the upper manifold (19) and around into the shaded conduits (11). The water cools in the shaded conduits (11) as a result of heat exchange with the outside environment (16) and becomes more dense relative to the water in the at least intermittently illuminated conduits (13). This causes the water to fall to the lower end of the shaded conduits (11). At the lower end of the shaded conduits (11), the water then flows back around through the lower manifold (20) and into the at least intermittently illuminated conduits (13). The shaded conduits (11) are situated between the at least intermittently illuminated conduits (13) and the incident radiation (15), limiting irradiation into the at least intermittently illuminated conduits (13) when the irradiation source is directly in front of the PATU, thus limiting peak irradiation and internal PATU temperatures. The heat exchange pipe material (12) would serve to shade the shaded conduits (11) and reflect excess radiation. The water recirculates between the at least intermittently illuminated series of conduits (13) and shaded series of conduits (11) indefinitely until new influent enters the PATU and forces water out through the effluent line (2). The effluent line (2) is connected to the upper manifold (19). Sloughed biofilm can be entrained in the system or carried out with the effluent. A siphon break (22) can be positioned along the effluent line (2) and above the hydraulic grade line (23) to prevent the entire PATU volume from draining with the effluent. Before and after the PATU, the influent and effluent can undergo settling, screening, filtration, or other solids separation techniques. An example of this is the installation of the PATU to treat the leachate from a Sun-Mar Centrex composter. The composter strains out fecal solids and the liquid blackwater leachate can then be used as influent for the PATU. Similarly, a food waste solids interceptor can be installed on a kitchen wastewater line to strain out solids prior to treatment with the PATU. In onsite residential wastewater treatment applications, the PATU can be used to treat mixed wastewater streams, grey water streams, or blackwater streams. Multiple PATU's can be installed in parallel or in series. The cumulative PATU volume can be sized to provide a minimum average hydraulic retention time. In environments where the convective recirculation rate is limiting process kinetics, a recirculation pump or turbine can be added to each PATU.

The PATU can be inoculated with the desired microbes and operated in the same manner as in Example 2.

### Example 7: PATU Installation In-Line with an at Least Intermittently Illuminated Series of Conduits and an at Least Intermittently Shaded Series of Conduits Made from Transparent Pipe Material without a Divider Plate

This example establishes the operation of a PATU in-line with the influent (1) and effluent (2) lines and configured with an at least intermittently illuminated series of conduits (13) and an at least intermittently shaded series of conduits (11) made of transparent pipe material (14) and without a divider plate (5), as illustrated in FIG. 7A and FIG. 7B.

In this configuration, the influent line (1) enters the PATU at the lower manifold (20) and the effluent line (2) leaves the PATU at the upper manifold (19). An increase in hydraulic head at the inlet relative to the outlet causes pretreated wastewater to flow into the PATU via the influent line (1) and treated effluent to flow out via the effluent line (2). Inside the PATU, water continuously recirculates between the at least intermittently illuminated series of conduits (13) and the at least intermittently shaded series of conduits (11) during the day. The PATU is preferably oriented in the general East-West direction such that the at least intermittently illuminated conduits (13) are exposed to incident radiation (15) in the morning while the at least intermittently shaded conduits (11) exist in their shadow and the at least intermittently shaded conduits (11) are exposed to incident radiation (15) in the afternoon while the at least intermittently illuminated conduits (13) exist in their shadow. In the morning, the water heats in the at least intermittently illuminated conduits (13) as a result of incident radiation (15) passing through the transparent pipe material (14) and becomes less dense relative to the water in the at least intermittently shaded conduits (11) that are shaded by profile of the at least intermittently illuminated conduits (13). This causes the water to rise to the upper end of the at least intermittently illuminated conduits (13). At the upper end of the at least intermittently illuminated conduits (13), the water flows through the upper manifold (19) and around into the at least intermittently shaded conduits (11). The water cools in the at least intermittently shaded conduits (11) as a result of heat exchange with the outside environment (16) and becomes more dense relative to the water in the at least intermittently illuminated conduits (13). This causes the water to fall to the lower end of the at least intermittently shaded conduits (11). At the lower end of the at least intermittently shaded conduits (11), the water then flows back around through the lower manifold (20) and into the at least intermittently illuminated conduits (13).

At midday, the process proceeds in reverse as water heats in the at least intermittently shaded conduits (11) as a result of incident radiation (15) passing through the transparent pipe material. The water becomes less dense relative to the water in the at least intermittently illuminated conduits (13) that are shaded by profile of the at least intermittently shaded conduits (11). This causes the water to rise to the upper end of the at least intermittently shaded conduits (11). At the upper end of the at least intermittently shaded conduits (11), the water flows through the upper manifold (19) and around into the at least intermittently illuminated conduits (13). The water cools in the at least intermittently illuminated conduits (13) as a result of heat exchange with the outside environment (16) and becomes more dense relative to the water in the at least intermittently shaded conduits (11). This causes the water to fall to the lower end of the at least intermittently illuminated conduits (13). At the lower end of the at least intermittently illuminated conduits (13), the water then flows back around through the lower manifold (20) and into the at least intermittently shaded conduits (11).

The water recirculates between the at least intermittently illuminated series of conduits (13) and the at least intermittently shaded series of conduits (11) indefinitely until new influent enters the PATU and forces water out through the effluent line (2). The effluent line (2) is connected to the upper manifold (19). Sloughed biofilm can be entrained in the system or carried out with the effluent. A siphon break (22) can be positioned along the effluent line (2) and above the hydraulic grade line (23) to prevent the entire PATU volume from draining with the effluent. Before and after the PATU, the influent and effluent can undergo settling, screening, filtration, or other solids separation techniques. An example of this is the installation of the PATU to treat the leachate from a Sun-Mar Centrex composter. The composter strains out fecal solids and the liquid blackwater leachate can then be used as influent for the PATU. Similarly, a food waste solids interceptor can be installed on a kitchen wastewater line to strain out solids prior to treatment with the PATU. In onsite residential wastewater treatment applications, the PATU can be used to treat mixed wastewater streams, grey water streams, or blackwater streams. Multiple PATU's can be installed in parallel or in series. The cumulative PATU volume can be sized to provide a minimum average hydraulic retention time. In environments where the convective recirculation rate is limiting process kinetics, a recirculation pump or turbine can be added to each PATU.

The PATU can be inoculated with the desired microbes and operated in the same manner as in Example 2.

### Example 8: PATU Installation In-Line with an at Least Intermittently Illuminated Series of Conduits and an at Least Intermittently Shaded Conduits Made from Transparent Pipe Material with a Divider Plate and No Gas Relief Valve

This example establishes the operation of a PATU in-line with the influent (1) and effluent (2) lines and configured with an at least intermittently illuminated series of conduits (13) and an at least intermittently shaded series of conduits (11) made of transparent pipe material (14) and with a divider plate (5), as illustrated in FIG. 8A and FIG. 8B.

In this configuration, the influent line (1) enters the PATU at the lower manifold (20) and the effluent line (2) leaves the PATU at the upper manifold (19). An increase in hydraulic head at the inlet relative to the outlet causes pretreated wastewater to flow into the PATU via the influent line (1) and treated effluent to flow out via the effluent line (2). Inside the PATU, water continuously recirculates between the at least intermittently illuminated series of conduits (13) and the at least intermittently shaded series of conduits (11) during the day. The PATU is oriented in the East-West direction such that the at least intermittently illuminated conduits (13) are exposed to incident radiation (15) in the morning and the at least intermittently shaded conduits (11) are exposed to incident radiation (15) in the afternoon. In the morning, the water heats in the at least intermittently illuminated conduits (13) as a result of incident radiation (15) passing through the transparent pipe material (14) and becomes less dense relative to the water in the at least intermittently shaded conduits (11) that are shaded by the divider plate (5). This causes the water to rise to the upper end of the at least intermittently illuminated conduits (13). At the upper end of the at least intermittently illuminated conduits (13), the water flows through the upper manifold (19) and around into the at least intermittently shaded conduits (11). The water cools in the at least intermittently shaded conduits (11) as a result of heat exchange with the outside environment (16) and becomes more dense relative to the water in the at least intermittently illuminated conduits (13). This causes the water to fall to the lower end of the at least intermittently shaded conduits (11). At the lower end of the at least intermittently shaded conduits (11), the water then flows back around through the lower manifold (20) and into the illuminated conduits (13).

At midday, the process proceeds in reverse as water heats in the at least intermittently shaded conduits (11) as a result of incident radiation (15) passing through the transparent pipe material. The water becomes less dense relative to the water in the at least intermittently illuminated conduits (13) that are shaded by the divider plate (5). This causes the water to rise to the upper end of the at least intermittently shaded conduits (11). At the upper end of the at least intermittently shaded conduits (11), the water flows through the upper manifold (19) and around into the at least intermittently illuminated conduits (13). The water cools in the at least intermittently illuminated conduits (13) as a result of heat exchange with the outside environment (16) and becomes more dense relative to the water in the at least intermittently shaded conduits (11). This causes the water to fall to the lower end of the at least intermittently illuminated conduits (13). At the lower end of the at least intermittently illuminated conduits (13), the water then flows back around through the lower manifold (20) and into the at least intermittently shaded conduits (11).

The water recirculates between the at least intermittently illuminated series of conduits (13) and the at least intermittently shaded series of conduits (11) indefinitely until new influent enters the PATU and forces water out through the effluent line (2). The effluent line (2) is connected to the upper manifold (19). Sloughed biofilm can be entrained in the system or carried out with the effluent. A siphon break (22) can be positioned along the effluent line (2) and above the hydraulic grade line (23) to prevent the entire PATU volume from draining with the effluent. Before and after the PATU, the influent and effluent can undergo settling, screening, filtration, or other solids separation techniques. An example of this is the installation of the PATU to treat the leachate from a Sun-Mar Centrex composter. The composter strains out fecal solids and the liquid blackwater leachate can then be used as influent for the PATU. Similarly, a food waste solids interceptor can be installed on a kitchen wastewater line to strain out solids prior to treatment with the PATU. In onsite residential wastewater treatment applications, the PATU can be used to treat mixed wastewater streams, grey water streams, or blackwater streams. Multiple PATU's can be installed in parallel or in series. The cumulative PATU volume can be sized to provide a minimum average hydraulic retention time. In environments where the convective recirculation rate is limiting process kinetics, a recirculation pump or turbine can be added to each PATU.

The PATU can be inoculated with the desired microbes in the same manner as in Example 2.

To initiate operation, the hydraulic circuit through the PATU is preferably filled with water. This can be done by initiating a wastewater flow to the PATU, opening the inlet valve (24) at the bottom of the PATU and the outlet valve (25) leaving the top of the PATU. Gas can leave via the effluent line (2) along with treated effluent and any sloughed biofilm carried with it. The effluent line (2) should have a sufficiently small diameter to carry gases bubbles to the siphon break (22).

### REFERENCES

Boelee, N.C., Temmink, H., Janssen, M., Buisman, C. J. N., Wijffels, R. H., 2014. Balancing the organic load and light supply in symbiotic microalgal-bacterial biofilm reactors treating synthetic municipal wastewater. Ecol. Eng. 64, 213-221.
Bosman C. E., McClelland Pott R. W., Bradshaw S. M. (2022). A Thermosiphon Photobioreactor for Photofermentative Hydrogen Production by Rhodopseudomonas palustris. Bioengineering (Basel). 9(8):344.
Bovinille, A. C. (2018). The development and characterization of a thermosiphon photobioreactor for the cultivation of photosynthetic bacteria [Stellenbock University].
Posadas, E., García-Encina, P.-A., Soltau, A., Domínguez, A., Díaz, I., & Muñoz, R. (2013). Carbon and nutrient removal from centrates and domestic wastewater using algal-bacterial biofilm bioreactors. Bioresource Technology, 139, 50-58.
Metcalf and Eddy, Inc., Tchobanoglous, G., Stensel, D., Tsuchihashi, R., Burton, F., 2013. Wastewater Engineering: Treatment and Resource Recovery.
Roberts, J. (2019). Impact of Microscreen Pretreatment and Biofilm Photobioreactor Design on Efficiency of Decentralized Wastewater Treatment [University of British Columbia]. https://open.library.ubc.ca/cIRcle/collections/ubctheses/24/items/1.0380207
Tuanet, K. (2019). Optimization of Algae Production on Urine. Algal Research, 44.
Westerling, K., 2014. Biological Treatment 101 Suspended Growth Vs. Attached Growth [WWW Document]. Water Online. URL https://www.wateronline.com/doc/biological-treatment-suspended-growth-vs-attached-growth-0001 (accessed Dec. 17, 2018).
Zamalloa, C., Boon, N., Verstraete, W., 2013. Decentralized two-stage sewage treatment by chemical-biological flocculation combined with microalgae biofilm for nutrient immobilization in a roof installed parallel plate reactor. Bioresource Technology, 130, 152-160.

All publications, including patent documents and scientific articles, referred to in this application and the bibliography and attachments are incorporated by reference in their entirety for all purposes to the same extent as if each individual publication were individually incorporated by reference.

All headings and titles are for the convenience of the reader and should not be used to limit the meaning of the text that follows the heading, unless so specified.

What is claimed is:

1. A photobioreactor (Passive Aerobic Treatment Unit (PATU)) for treating wastewater from a preferably liquid influent stream using at least one biofilm, comprising:
a) at least one illuminated conduit oriented on an angle from the horizontal with a transparent face to admit incident radiation and pass heat to or from the outside environment;
b) at least one shaded conduit that runs adjacent to said at least one illuminated conduit and passes heat to or from the outside environment;
c) at least one connection between said at least one illuminated conduit and said at least one shaded conduit at high and low points such that said wastewater recirculates by convection as a result of imbalanced heating or cooling of said at least one illuminated conduit and said at least one shaded conduit;
d) at least one biofilm provided on at least a portion of at least one internal surface of said device;
e) at least one illumination means for applying to said at least one illuminated conduit and the microorganisms therein; and
f) at least one inlet port and at least one outlet port.

2. The device of claim 1,
wherein said at least one illuminated conduit comprises at least one flat panel conduit that comprises at least in part at least one transparent face to at least intermittently admit incident radiation.

3. The device of claim 1,
whereby said at least one illuminated conduit comprises a series of parallel transparent conduits that admit incident radiation at least intermittently.

4. The device of claim 1,
wherein said at least one shaded conduit comprises a heat exchange element.

5. The device of claim 1,
wherein said at least one shaded conduit comprises a series of thermally conductive parallel heat exchange conduits that run adjacent to said at least one illuminated conduit and increase the area available for heat exchange.

6. The device of claim 1,
wherein said at least one shaded conduit comprises at least one flat panel conduit that is shaded by said at least one illuminated conduit and has at least one thermally conductive back face.

7. The device of claim 1,
wherein said at least one shaded conduit comprises a series of parallel transparent conduits that admit incident radiation.

8. The device of claim 7,
wherein said at least one illuminated conduit is only intermittently illuminated during the day while said at least one shaded conduit is intermittently shaded during the day as they are oriented such that the former receives incident radiation in the morning while shading the latter and the latter receives incident radiation in the afternoon while shading the former.

9. The device of claim 1,
wherein said at least one illuminated conduit and said at least one shaded conduit connect:
(i) at the upper end of said device;
(ii) below said device;
(iii) by way of at least one settling chamber from which said at least one influent pipe ascends to said at least one illuminated conduit, and to which said at least one effluent pipe descends from said at least one shaded conduit.

10. The device of claim 1,
wherein said at least one illuminated conduit and said at least one shaded conduit connect at the upper end of said device and again at the lower end of said device and said at least one influent pipe and said at least one effluent pipe can connect to the upper end and lower end of said device.

11. The device of claim 1,
wherein said at least one biofilm comprises autotrophic, phototropic, mixotrophic, chemotrophic, heterotrophic microorganisms, or a combination thereof.

12. The device of claim 1,
wherein said at least one biofilm is provided on at least one of said at least one illuminated conduit, said at least one at least intermittently shaded conduit, or a combination thereof.

13. The device of claim 1,
wherein said a least one illumination means comprise:
a) direct sunlight;
b) sunlight passed through a window or light filter;
c) sunlight redirected using a solar tube, fiberoptics, or reflector;
d) artificial full spectrum lighting;
e) artificial lighting optimized for photosynthetic active radiation;
f) bioluminescence;
g) nuclear radiation; or
h) a combination thereof.

14. The device of claim 1,
wherein at least one of said at least one illuminated conduit and at least one of said at least one shaded conduit are separated, in whole or in part, by an at least one divider plate.

15. The device of claim 14,
wherein said at least one insulative divider plate shades said at least one at least intermittently shaded conduit.

16. The device of claim 14,
wherein said at least one divider plate shades said at least one at least intermittently shaded conduits, reflects or absorbs incident radiation as needed to optimize the temperature, convective recirculation, and incident radiation exposure of the illuminated conduits(s) for the growth of microorganisms inside the device, and thermally separates the illuminated and shaded conduits except where they meet at the upper and lower ends of said device.

17. The device of claim 7,
wherein at least one of said at least one illuminated conduit and said at least one shaded conduit are separated, in whole or in part, by an at least one divider plate.

18. The device of claim 17,
wherein said at least one divider plate alternately shades said at least one at least intermittently shaded conduits and said at least one at least intermittently illuminated conduits depending on the position of the sun in the sky.

19. The device of claim 1,
wherein said at least one inlet port transports influent into said device.

20. The device of claim 1,
wherein said at least one outlet port transports effluent out of said device.

21. The device of claim 1,
wherein at least one gas relief valve is provided at the top of said device for removing gas build-up.

22. The device of claim 21,
wherein said at least one gas relief valve is connected to a pump to facilitate removing gas build-up as said at least one gas relief valve is above the hydraulic grade line.

23. The device of claim 1,
wherein said at least one gas relief valve can passively release gas by gravity as said at least one gas relief valve is below the hydraulic grade line.

24. The device of claim 1,
wherein an at least one outlet port is provided at the top of said device.

25. The device of claim 24,
wherein said at least one outlet port facilitates the removal of gas build-up along with liquid effluent.

26. The device of claim 1,
further comprising baffles within said device are used to prevent hydraulic short-circuiting.

27. The device of claim 1,
wherein said device is mounted as a skylight or window between two environments and the temperature difference between the two environments is used to drive the convective recirculation of said device.

28. The device of claim 1,
wherein said device comprises at least one tank to store untreated wastewater, partially treated wastewater, treated wastewater, or a combination thereof.

29. The device of claim 1,
wherein multiple devices are connected in parallel.

30. The device of claim 1,
wherein multiple devices are connected in series.

31. The device of claim 1,
wherein said device is preceded, followed, or a combination thereof, by solids removal.

32. The device of claim 31,
wherein said solid removal comprises settling, screening, filtration, or a combination thereof.

33. The device of claim 1,
wherein said device is preceded by solids removal.

34. The device of claim 33,
wherein said solid removal comprises settling, screening, filtration, or a combination thereof.

35. The device of claim 1,
wherein said device is a closed system and thereby can operate passively at, above, or below the influent hydraulic grade line.

36. The device of claim 1,
wherein said wastewater enters and leaves said device by gravity.

37. The device of claim 1,
wherein said wastewater is pumped to and from said device.

38. The device of claim 1,
wherein a recirculation pump is used to supplement the convective recirculation rate into and out of said device.

39. The device of claim 1,
wherein said device contains baffles that prevent hydraulic short circuiting through said device.

40. A method of treating wastewater, comprising:
a) providing at least one device of claim 1;
b) operably engaging said at least one device of claim 1 with at least one source of wastewater to be treated;
c) operating said at least one device of claim 1 with said at least one source of wastewater;
wherein said wastewater is treated.

41. The device of claim 40,
wherein said wastewater comprises sewage, cistern waste, household waste, municipal waste, industrial waste, animal waste, digestate, leachate, farm waste, run-off, a polluted water body, or a combination thereof.

42. The device of claim 41,
wherein said wastewater is untreated, partially treated, fully treated, or a combination thereof.
